(19) United States
(12) Patent Application Publication
(10) Pub. No.: US 2004/0204316 A1
(43) Pub. Date: Oct. 14, 2004

(54) Heat-sensitive recording material and preparation method thereof

(75) Inventor: Mitsuyuki Tsurumi, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/819,975

(22) Filed: Apr. 8, 2004

(30) Foreign Application Priority Data
Apr. 11, 2003 (JP) 2003-107541
Mar. 8, 2004 (JP) 2004-64822

(51) Int. Cl. G03C 1/72; B41M 5/20

(52) U.S. Cl. 503/201

(57) ABSTRACT

The invention provides a heat-sensitive recording material and a method for preparing the material. The material has a substrate and a plurality of layers formed on the substrate is provided. Among the plurality of layers, at least two layers are heat-sensitive recording layers, and at least one layer among the plurality of layers contains gelatin or a gelatin derivative as a binder, and is hardened with an active olefin. It is preferable that the plural layers include at least one of an intermediate layer and a protective layer, and that at least one of these is the layer hardened with the active olefin. It is preferable that the active olefin is contained in an amount of 1 to 40% by mass relative to the gelatin or gelatin derivative.

### CROSS-REFERNCE TO RELATED APPLICATIONS

This application claims benefit and priority to Japanese Patent Application Nos. 2003-107541, filed on Apr. 11, 2003, and 2004-64822, filed on Mar. 8, 2004 which is incorporated herein by reference in its entirety for all purposes.

### BACKGROUND OF THE INVENTION

1. Field of the Invention

The present invention relates to a color-developing heat-sensitive recording material, which provides images having excellent image quality. Further, the present invention relates to a method for preparing a color-developing heat-sensitive recording material.

2. Description of the Related Art

In recent years, much effort has gone into developing heat-sensitive recording due to the fact that it can be conducted using simple recording devices while being highly reliable and requiring little maintenance. Recently, multi-color recording is conducted utilizing the advantages of heat-sensitive recording.

Multi-color heat-sensitive recording materials have a substrate and multiple heat-sensitive recording layers formed on the substrate, and an intermediate layer is commonly formed between the heat-sensitive recording layers, with a protective layer formed on the outermost layer. In the protective layer, polyvinyl alcohol is commonly used as a water-soluble binder. Since a thermal head comes in contact with the protective layer, the mechanical strength of the protective layer is preferably increased by crosslinking polyvinyl alcohol using a crosslinking agent. However, the use of boric acid as the polyvinyl alcohol crosslinking agent is problematic in that the viscosity of the protective layer coating solution increases, making the coating solution likely to gelatinize during coating. Therefore, a method is employed where a layer containing gelatin and boric acid is simultaneously formed adjacent to the protective layer, thereby diffusing the boric acid in the protective layer and crosslinking the protective layer (see Japanese Patent Application Laid-Open (JP-A) No. 6-344666). In this case, even though a film hardener is included in the gelatin layer, it is not used to crosslink the gelatin layer, but rather to crosslink the polyvinyl alcohol of the adjacent protective layer.

Other known methods include employing a layer containing gelatin as the intermediate layer (see JP-A No. 4-35986) and an example of adding film hardener to the intermediate layer containing gelatin is also known (see JP-A No. 2002-264523, paragraphs 0168 to 0169, and JP-A No. 2000-272246, paragraph 0083).

Meanwhile, in multi-color heat-sensitive recording materials having a layer containing gelatin as a binder, the gloss of the image sometimes changes unnaturally at the portion where high-intensity energy is applied when various images are printed, and image disturbance sometimes causes reduction in color-developing density. Therefore, printing is conducted by using lower energy, even at the portion where high-intensity energy is applied, and it has been impossible to exhibit maximum color-developing density.

Nonetheless, there has been little awareness regarding the effect of adding the film hardener to a gelatin-containing intermediate layer. Specifically, there has been no recognition whatsoever that the addition of film hardener exerts certain effects on gloss and color-developing density at the portion where high-intensity energy is applied.

### SUMMARY OF THE INVENTION

The present invention has been made in view of the above circumstances and provides a heat-sensitive recording material. The invention provides a heat-sensitive recording material that provides excellent gloss and image density, even at the portion where high-intensity energy is applied.

The present inventors have extensively studied the addition of film hardeners to layers containing gelatin, and thus the following invention has been completed.

Namely, the present invention provides a heat-sensitive recording material comprising a substrate and a plurality of layers formed on the substrate, wherein at least two layers among the plurality of layers are heat-sensitive recording layers; and at least one layer among the plurality of layers contains gelatin or a gelatin derivative as a binder, and is hardened with an active olefin.

Further, the present invention provides a method for preparing the heat-sensitive recording material.

### DETAILED DESCRIPTION OF THE INVENTION

The heat-sensitive recording material of the present invention comprises at least two or more heat-sensitive recording layers on a substrate. One or more of intermediate layers that reside between heat-sensitive recording layers, back coat layers, and/or protective layers may be further provided thereto. The heat-sensitive recording material of the invention is characterized by having a layer containing gelatin or a gelatin derivative (hereinafter, occasionally referred to as “gelatin”) as a binder, wherein the gelatin is to be crosslinked with an active olefin (i.e., the layer is hardened). The active olefin may be added to any of heat-sensitive recording layers, intermediate layers, protective layers, back coat layers, and undercoat layers. Among these layers, at least one of the intermediate layer and the protective layer is preferably the layer containing the active olefin, and it is specifically preferable that the intermediate layers contain the active olefin.

In view of an improvement in image density upon application of high-intensity energy, the active olefin is preferably added in an amount of 1 to 40%, more preferably 2 to 25%, further preferably 3.5 to 20.0% by mass relative to the entire gelatin in the heat-sensitive recording material.

The active olefin is preferably a compound having two or more double bonds in the molecule, especially double bonds activated by an electron attracting group adjacent to the double bonds, and more preferably a compound having a non-substituted vinyl group activated by an electron attracting group adjacent to double bonds.

Preferable examples of adjacent electron attracting group include those having —COR group, —OSO₂R group, —SO₂R group, —SO₂NR¹R² group, —CONR¹R² group, —COOR group or the like. In the groups, R, R¹ and R² represent a hydrogen atom, a halogen atom, an alkyl group, an aryl group or an acyl group. When R, R¹ and R² represent an alkyl group, they may be substituted or non-substituted, may be straight-chain or branched, and may have an unsaturated bond. When R, R¹ and R² represent an aryl group, they may be substituted or non-substituted. R, R¹ and R² may form a ring.

In addition, a compound, which serves as the active olefin at high pH and reacts with gelatin, is also included in the active olefin of the invention, and such an active olefin is preferably used in the invention.

Specific examples of the active olefin include, but are not limited to, the following.

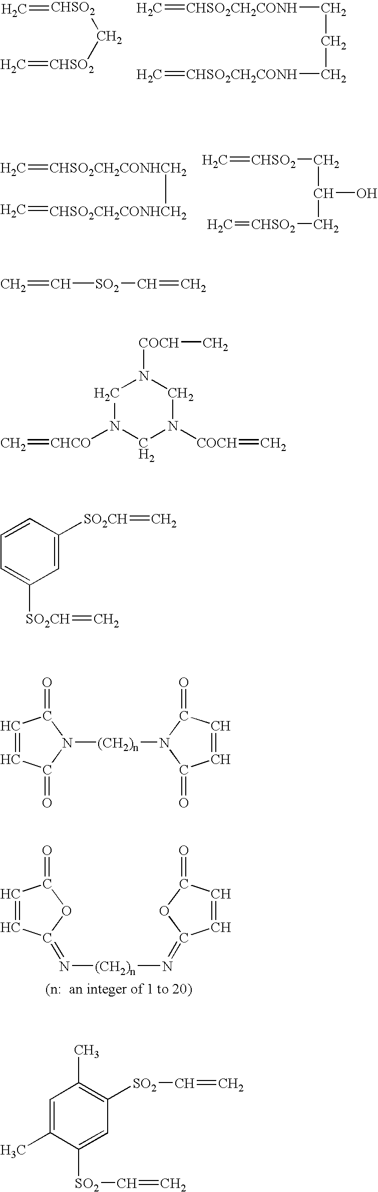

In the invention, since the layer containing gelatin as a binder is hardened, gloss and image density at the portion where high-intensity energy is applied are excellent. Also head contamination is improved (the number of prints which indicates printing durability increases) and the sensitivity curve of each color development exhibits a sharp rise in the vicinity of Dmin.

The binder for use in each layer of the heat-sensitive recording material of the invention, such as a heat-sensitive recording layer, an intermediate layer and a protective layer, is preferably any of a variety of water-soluble polymer compounds. In particular, such a binder preferably has such solubility that 5% by mass or more thereof can be dissolved in each corresponding liquid at each of the temperature at the time when microcapsules are prepared, the temperature at the time when an emulsion of a coupler or the like is prepared, and the temperature at the time when a coating solution for each layer is applied in the process of making the heat-sensitive recording material.

Such a binder is preferably any of gelatins and particularly preferably an alkali-treated gelatin having a low isoelectric point or a gelatin derivative (such as phthalated gelatin) whose amino groups have been partially modified by reaction. The isoelectric point of the gelatin is preferably 7.0 or less, more preferably 6.5 or less, still more preferably 6.0 or less.

The gelatin having a low isoelectric point preferably has a number average molecular weight of from 8,000 to 200,000, more preferably from 10,000 to 150,000, still more preferably from 30,000 to 100,000.

Any of such gelatins may be used in emulsification when the microcapsules are prepared or may be used as a binder when the emulsion of the coupler or the like is prepared. Any of such gelatins may also be added to the coating solution for the heat-sensitive recording layer when the heat-sensitive recording material is produced, or may be used as a binder for forming the intermediate layer or the protective layer.

The layer constitution of a heat-sensitive recording material, which develops a color by applying heat imagewise, will be described below.

Heat-Sensitive Recording Layer

The heat-sensitive recording layer contains a color-developing component and optionally contains other components such as a binder and a base. As the color-developing component, conventionally known color-developing components can be used, in addition to a combination of a diazonium salt compound and a coupler capable of reacting with the diazonium salt compound thereby forming a dye, and a combination of an electron-donating dye precursor and an electron-accepting compound capable of reacting with the electron-donating dye precursor, thereby developing a color. The diazonium salt compound and the electron-donating dye precursor are preferably contained in microcapsules.

Diazonium Salt Compound

The diazonium salt compound used in the invention is represented by the following formula (1):

Ar—N₂⁺.X⁻ Formula (1)

In formula (1), Ar represents an aromatic ring group and X⁻ represents an acid anion.

In formula (1), Ar represents a substituted or non-substituted aryl group. In case the aryl group is substituted, examples of the substituent include an alkyl group, an alkoxy group, an alkylthio group, an aryl group, an aryloxy group, an arylthio group, an acyl group, an alkoxycarbonyl group, a carbamoyl group, a carboamide group, a sulfonyl group, a sulfamoyl group, a sulfonamide group, an ureide group, a halogan group, an amino group, and a heterocyclic group, and these substituents may be further substituted.

The aryl group is preferably an aryl group having 6 to 30 carbon atoms and includes, for example, a phenyl group, a 2-methylphenyl group, a 2-chlorophenyl group, a 2-methoxyphenyl group, a 2-butoxyphenyl group, a 2-(2-ethylhexyloxy)phenyl group, a 2-octyloxyphenyl group, a 3-(2,4-di-t-pentylphenoxyethoxy)phenyl group, a 4-chlorophenyl group, a 2,5-dichlorophenyl group, a 2,4,6-trimethylphenyl group, a 3-chlorophenyl group, a 3-methylphenyl group, a 3-methoxyphenyl group, a 3-butoxyphenyl group, a 3-cyanophenyl group, a 3-(2-ethylhexyloxy)phenyl group, a 3,4-dichlorophenyl group, a 3,5-dichlorophenyl group, a 3,4-dimethoxyphenyl group, a 3-(dibutylaminocarbonylmethoxy)phenyl group, a 4-cyanophenyl group, a 4-methylphenyl group, a 4-methoxyphenyl group, a 4-butoxyphenyl group, a 4-(2-ethylhexyloxy)phenyl group, a 4-benzylphenyl group, a 4-aminosulfonylphenyl group, a 4-N,N-dibutylaminosulfonylphenyl group, a 4-ethoxycarbonylphenyl group, a 4-(2-ethylhexylcarbonyl)phenyl group, a 4-fluorophenyl group, a 3-acetylphenyl group, a 2-acetylaminophenylgroup, a 4-(4-chlorophenylthio)phenyl group, a 4-(4-methylphenyl)thio-2,5-butoxyphenyl group, and a 4-(N-benzyl-N-methylamino)-2-dodecyloxycarbonylphenyl group.

These groups may be further substituted with an alkyloxy group, an alkylthio group, a substituted phenyl group, a cyano group, a substituted amino group, a halogen atom, and a heterocyclic group.

X⁻ represents an acid anion. The acid anion may be any of an inorganic anion and an organic anion.

Preferable examples of the inorganic anion include hexafluorophosphoric acid ion, fluoroboric acid ion, chloride ion, and sulfuric acid ion. Among these inorganic anions, a hexafluorophosphoric acid ion and a fluoroboric acid ion are particularly preferable. Preferable examples of the organic anion include a polyfluoroalkylcarboxylic acid ion, a polyfluoroalkylsulfonic acid ion, a tetraphenylboric acid ion, an aromatic carboxylic acid ion, and an aromatic sulfonic acid ion. Among these organic anions, a polyfluoroalkylsulfonic acid ion, a tetraphenylboric acid ion, and an aromatic carboxylic acid ion are particularly preferable.

Among diazonium salt compounds represented by formula (1), a compound represented by the following formula (2) is preferable because it can effectively increase the concentration of the diazonium salt compound. Although the concentration can be increased, fog density of the ground portion is not increased during printing or storage.

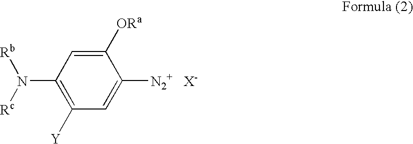

In formula (2), R^{a}, R^{b} and R^{c} each independently represent an alkyl group or an aryl group and may be substituted or non-substituted, and R^{a} to R^{c} may be the same or different.

In case they are substituted, examples of the substituents include an alkyl group, an alkoxy group, an alkylthio group, an aryl group, an aryloxy group, an arylthio group, an acyl group, an alkoxycarbonyl group, a carbamoyl group, a carboamide group, a sulfonyl group, a sulfamoyl group, a sulfonamide group, an ureide group, a halogen atom, an amino group, and a heterocyclic group.

The alkyl group represented by R^{a} to R^{c} may be straight-chain or branched and is preferably an alkyl group having 1 to 18 carbon atoms, and examples thereof include a methyl group, an ethyl group, a 1-hexyl group, a 2-ethylhexyl group, a 3,5,5-trimethylhexyl group, a 1-dodecyl group, a 1-octadecyl group, a 2-phenoxy-1-ethyl group, a 4-(2,5-di-t-amylphenoxy)-1-butyl group, and a phenoxymethyl group. Among these alkyl groups, an alkyl group having 4 to 10 carbon atoms is more preferable, and a 1-hexyl group, a 2-ethylhexyl group and a 3,5,5-trimethylhexyl group are particularly preferable.

The aryl group represented by R^{a} to R^{c} is preferably an aryl group having 4 to 24 carbon atoms, and examples thereof include a phenyl group, a 4-ethoxyphenyl group, a 4-(di-n-butylcarbamoyl)phenyl group, a 2,4-dichlorophenyl group, a 2-ethoxycarbonylphenyl group, a 1-naphthyl group, 2-pyridyl group, a 4-methoxycarbonyl-2-theinyl group, and a 2,4-di-t-amylphenyl group. Among these aryl groups, an aryl group having 6 to 18 carbon atoms is preferable, and a phenyl group, a 4-ethoxyphenyl group, a 2,4-di-n-butoxyphenyl group, and a 2,4-di-t-amylphenyl group are particularly preferable.

Among aforementioned groups, an n-hexyl group, a 2-ethylhexyl group, a 3,5,5-trimethylhexyl group, a 4-ethoxyphenyl group, and a 2,4-di-t-amylphenyl group are preferable as R^{a} to R^{c}.

Y in formula (2) represents a hydrogen atom or —OR^{d}. R^{d} represents an alkyl group or an aryl group, and may be substituted or non-substituted. In case Y is substituted, examples of the substituent include the same substituents as that can substitute on the alkyl group represented by R^{a} to R^{c}.

The alkyl group represented by Rd is preferably an alkyl group having 1 to 18 carbon atoms, and examples thereof include a methyl group, an ethyl group, an n-hexyl group, an n-dodecyl group, an n-octadecyl group, a 2-(n-butoxy)ethyl group, a 3-pentyl group, a 3,5,5-trimethylhexyl group, a 2-(4-methoxyphenyl)-1-propyl group, and a di-n-butylcarbamoylmethyl group. Among these alkyl groups, an alkyl group having 1 to 10 alkyl group is preferable, and an ethyl group, a 3-pentyl group, 3,5,5-trimethylhexyl group, and a 2-(4-methoxyphenyl)-1-propyl group are particularly preferable.

The aryl group represented by R^{d} has the same meaning as that of the aryl group represented by R^{a} to R^{c} and also its preferable embodiments are the same.

Among these groups, an ethyl group, a 3-pentyl group, a 3,5,5-trimethylhexyl group, a phenyl group, and a 4-ethoxyphenyl group are preferable as Y.

X⁻ in formula (2) represents an acid anion and has the same meaning as that of X⁻ in formula (1), and also its preferable embodiments are the same.

Among the compounds represented by formula (2), a compound represented by the following formula (3) or (4) (diazonium salt compound) is more preferable. The compound is a benzenediazonium salt compound which has a branched alkoxy group at the 2-position of the benzene ring and a di(alkoxycarbonylpropyl)amino group at the 4-position. Because of its structure, the diazonium salt compound itself is stable and does not cause colored stains due to photolysis, and also it can maintain white properties and is excellent in light fastness after color development, and further, there is no fear of explosion.

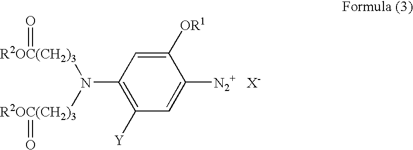

In formula (3), R¹ represents a branched alkyl group.

The branched alkyl group represented by R¹ may be non-substituted or substituted. In case the branched alkyl group is substituted, preferable examples of the substituent include a phenyl group, a halogen atom, an alkoxy group, an aryloxy group, an alkoxycarbonyl group, an acylamino group, a carbamoyl group, a cyano group, an alkylsulfonyl group, an arylsulfonyl group, a sulfonamide group, a sulfamoyl group, an acyl group, and a heterocyclic group.

The branched alkyl group is preferably a branched alkyl group having 3 to 30 carbon atoms in total, and more preferably an alkyl group having 3 to 15 carbon atoms in total, and preferable examples thereof include a 2-propyl group, a 2-butyl group, 2-methylpropyl group, a 2-pentyl group, a 3-pentyl group, a 2,2-dimethylpropyl group, a 3-methylbutyl group, a 2-hexyl group, a 4-methylpentyl group, a 2-octyl group, a 2-ethylhexyl group, a 3,5,5-trimethylhexyl group, a 2-butyloctyl group, a 2-hexyldecyl group, a 2-phenoxypropyl group, and a 2-(4-methoxyphenoxy)propyl group.

Among these branched alkyl groups, a 2-methylpropyl group, 3-pentyl group, a 2,2-dimethylpropyl group, a 3-methylbutyl group, a 2-ethylhexyl group, a 3,5,5-trimethylhexyl group, a 2-butyloctyl group, and a 2-hexyldecyl group are preferable.

R² and R³ each independently represents an alkyl group. The alkyl group may be non-substituted or substituted. In case they are substituted, preferable examples of the substituent include a phenyl group, a halogen atom, an alkoxy group, an aryloxy group, an alkoxycarbonyl group, an acylamino group, a carbamoyl group, a cyano group, an alkylsulfonyl group, an arylsulfonyl group, a sulfonamide group, a sulfamoyl group, an acyl group, and a heterocyclic group.

The alkyl group represented by R² or R³ is preferably an alkyl group having 1 to 10 carbon atoms in total, and more preferably an alkyl group having 1 to 4 carbon atoms in total, and preferable examples thereof include a methyl group, an ethyl group, a propyl group, a 2-propyl group, a butyl group, a 2-butyl group, a pentyl group, a 2-methoxyethyl group, a 2-ethoxyethyl group, a 2-propoxyethyl group, and a 2-butoxyethyl group.

Among these alkyl groups, a methyl group, an ethyl group, a propyl group, a 2-propyl group, and a butyl group are preferable.

R² and R³ may be combined with each other to form a ring. Preferable examples of R² or R³ include an alkylene group, an arylene group, and a polyethyleneoxy group. Among these groups, an ethylene group, a propylene group, and a phenylene group are preferable.

Y has the same meaning as that of Y in formula (2), and also its preferable embodiments are the same. X⁻ represents an acid anion and the acid anion has the same meaning as that of X⁻ in formula (1), and also its preferable embodiments are the same.

Among the groups represented by Y, a hydrogen atom is particularly preferable. Among diazonium salt compounds represented by formula (3), a diazonium salt represented by the following formula (4) is particularly preferable. The diazonium salt compound having such a structure has a maximum absorption wavelength of about 370 nm and can be easily decomposed with ultraviolet light.

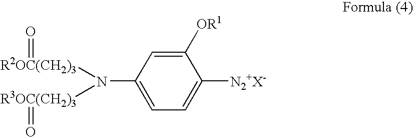

R¹ in formula (4) represents a branched alkyl group and the branched alkyl group has the same meaning as that of R¹ in formula (3), and also its preferable embodiments are the same. R² and R³ each independently represents an alkyl group and the alkyl group has the same meaning as that of R² and R³ in formula (3), and also its preferable embodiments are the same. X-represents an acid anion and the acid anion has the same meaning as that of X⁻ in formula (1), and also its preferable embodiments are the same.

In the diazonium salt compound represented by formula (3) or (4), at least one of R¹, R² and R³ may also have a diazoaryl group as the substituent, and a bis-form or a multimer may be formed.

Specific examples of the diazonium salt compounds represented by formulas (1) to (4) include diazonium salt compounds described in the paragraphs 44 to 49 of JP-A No. 7-276808, and also preferable specific examples (compounds A-1 to A-24) will be described below. In the invention, the diazonium salt compounds are not limited thereto.

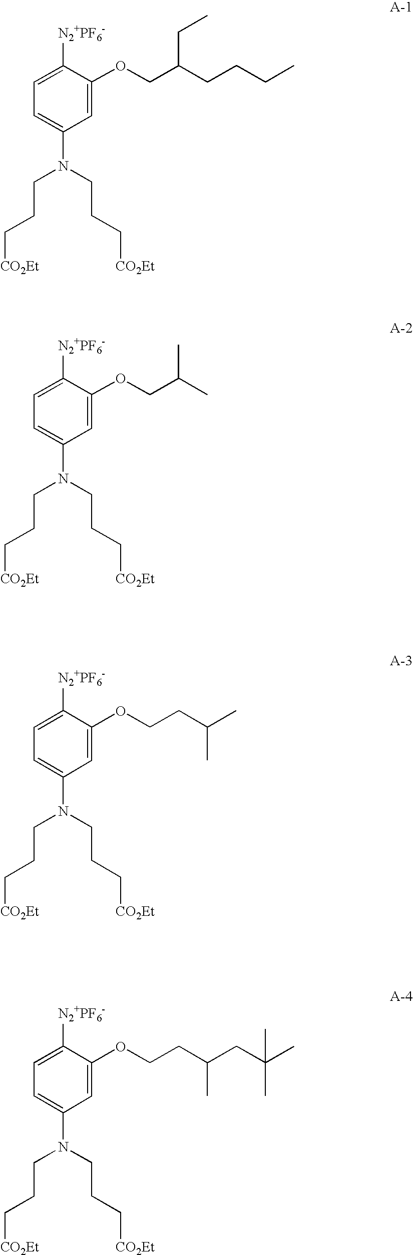

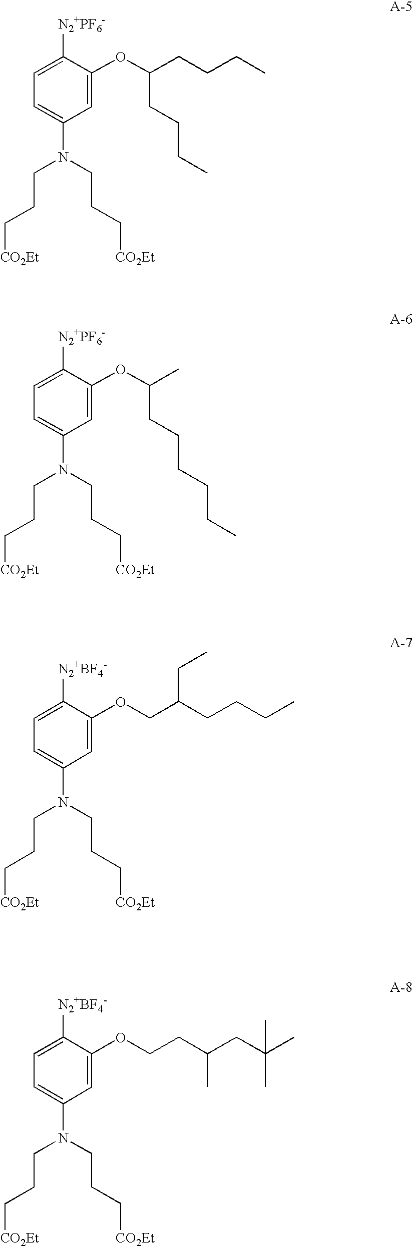

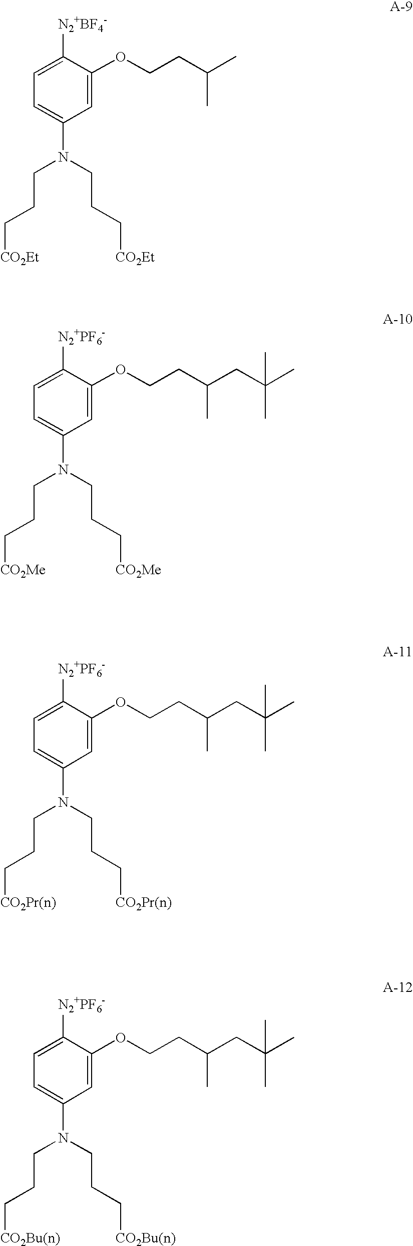

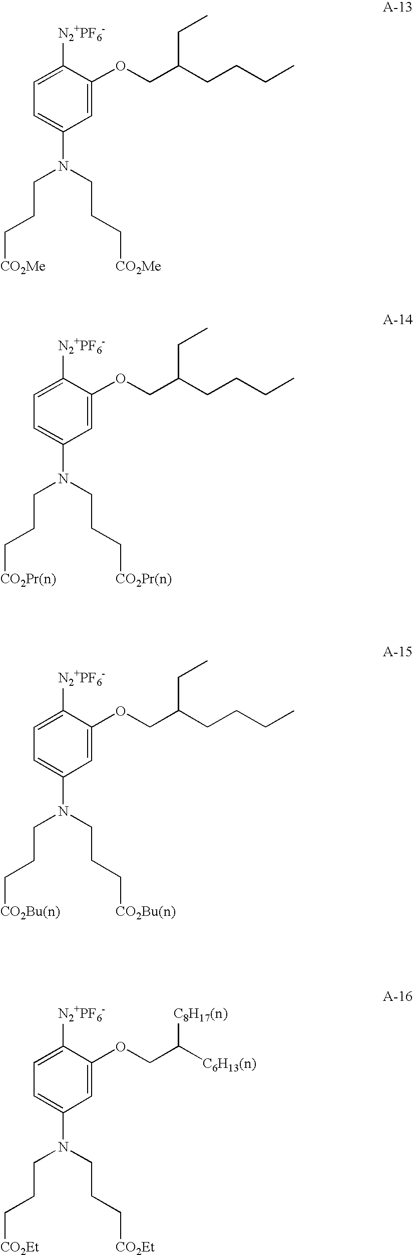

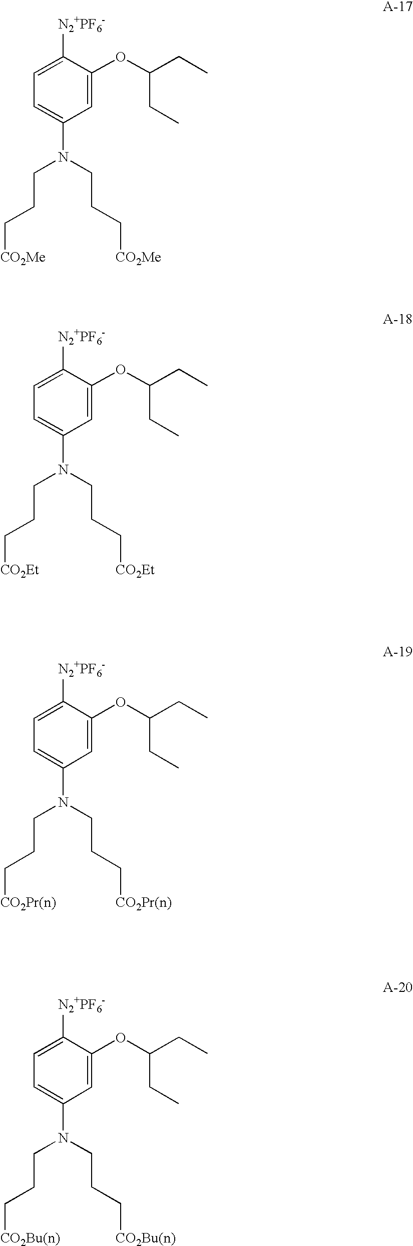

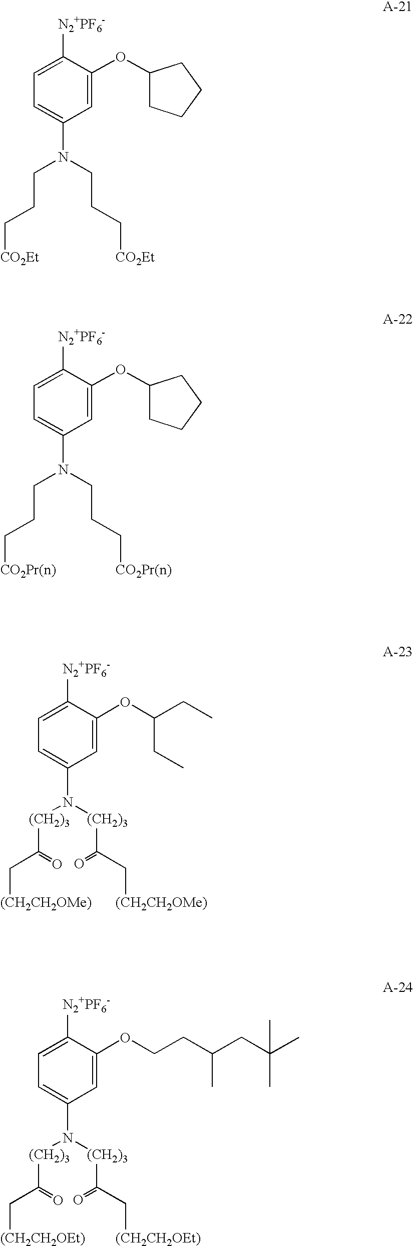

Among these diazonium salt compounds, those having a maximum absorption wavelength (λmax) in a range from 330 to 390 nm are preferable because of excellent photofixing properties (for example, fixing degree and fixing rate).

The diazonium salt compound preferably has 12 or more carbon atoms, solubility in water of 1% or less, and solubility in ethyl acetate of 5% or more.

The diazonium salt compounds represented by formulas (1) to (4) can be prepared by an already-known method. For example, they can be obtained by the diazonization of corresponding aniline in an acidic solvent using sodium nitrate, sulfuric acid and isoamyl nitrite.

The diazonium salt compounds represented by formulas (1) to (4) may be in the form of either oil or crystal, and is preferably in the form of a crystal at normal temperature in view of handling properties. These diazonium salt compounds may be used alone or in combination according to the purpose of controlling hue.

The diazonium salt compounds represented by formulas (2) to (4) react with a coupler compound described later thereby to develop a color and is excellent in color-developing properties and enable high color-developing density, and also a color-developing dye is excellent in light fastness. Moreover, the diazonium salt compounds are excellent in photolytic properties at a wavelength range in a range from 350 to 430 nm from a fluorescent lamp and have high-speed photolytic properties enough to complete fixation even by irradiation with light for a short time. Because of less coloring (i.e., occurrence of stains) due to photolysis, the diazonium salt compounds are markedly suited for a color-developing component used as a photofixing heat-sensitive recording material, and can form a high-contrast image which is excellent in fastness and white properties of the ground portion.

Coupler Compound

In the invention, the heat-sensitive recording layer contains aforementioned diazonium salt compound, and a coupler compound which reacts with the diazonium salt compound thereby to develop a color (hereinafter, merely referred to as a “coupler”, sometimes).

The coupler is described in detail in Japanese Patent Application Publication (JP-B) Nos. 4-75147, 6-55546, 6-79867, JP-A Nos. 4-201483, 60-49991, 60-242094, 61-5983, 63-87125, 4-59287, 5-185717, 7-88356, 7-96671, 8-324129, 9-38389, 5-185736, 5-8544, 59-190866, 62-55190, 60-6493, 60-259492, 63-318546, 4-65291, 5-185736, 5-204089, 8-310133, 8-324129, 9-156229, and 9-175017, and the following compounds (B-1 to B-24, (1) to (28), II-1 to II-11, and VI-1 to VI-6) are described as specific examples of the compound. In the invention, specific examples are not limited thereto.

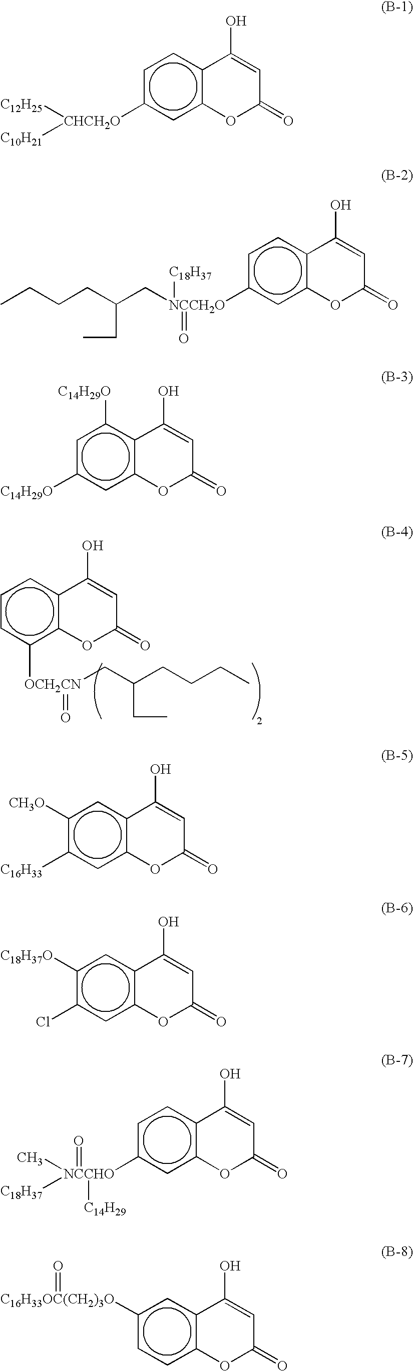

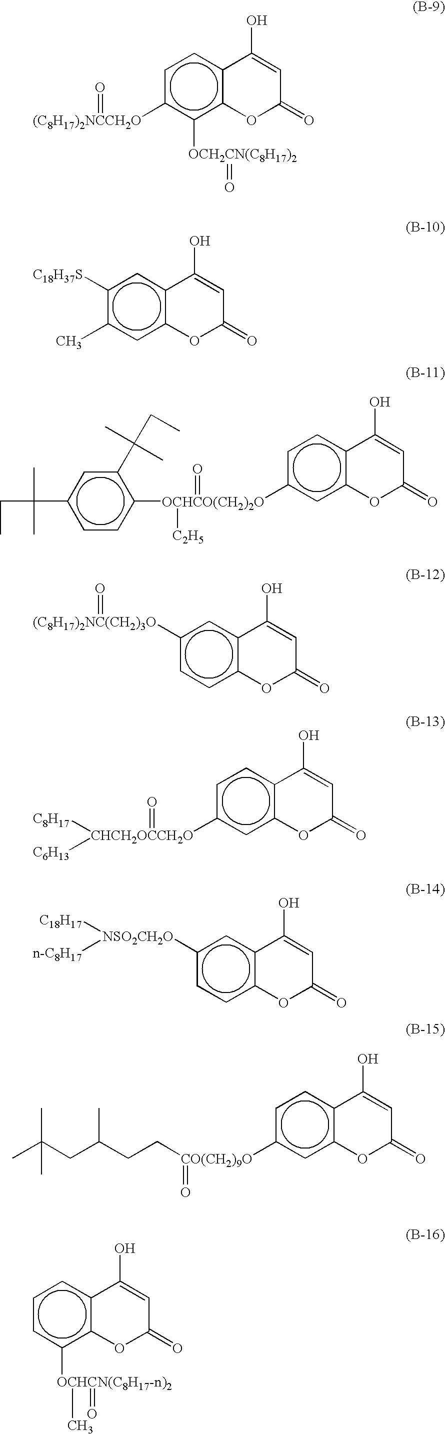

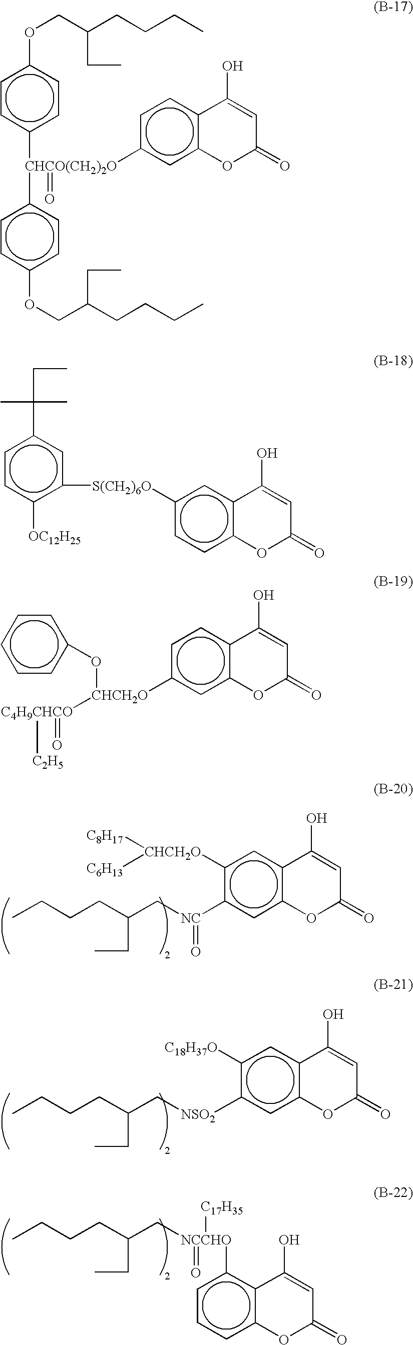

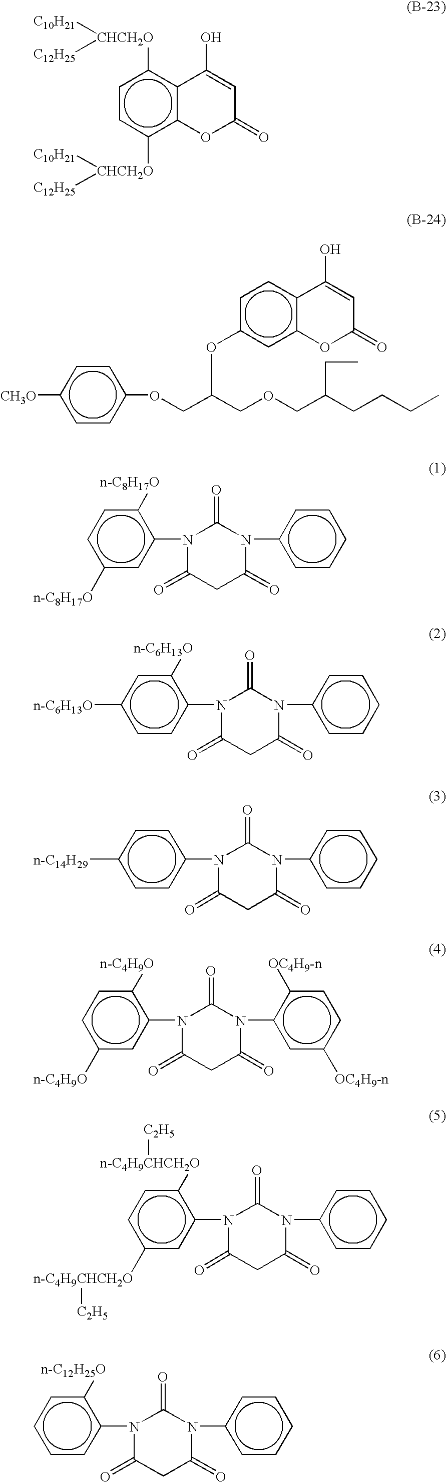

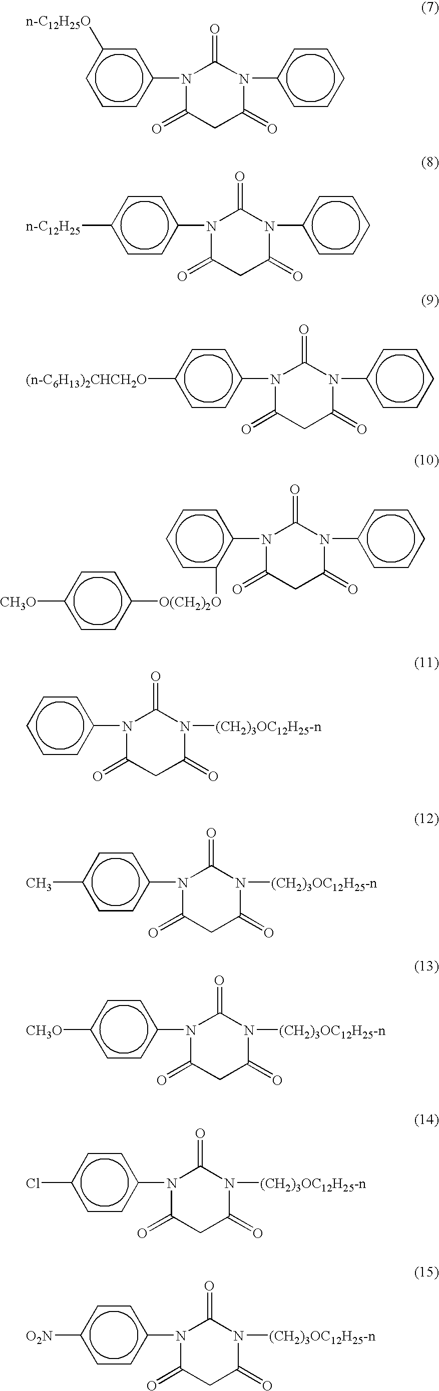

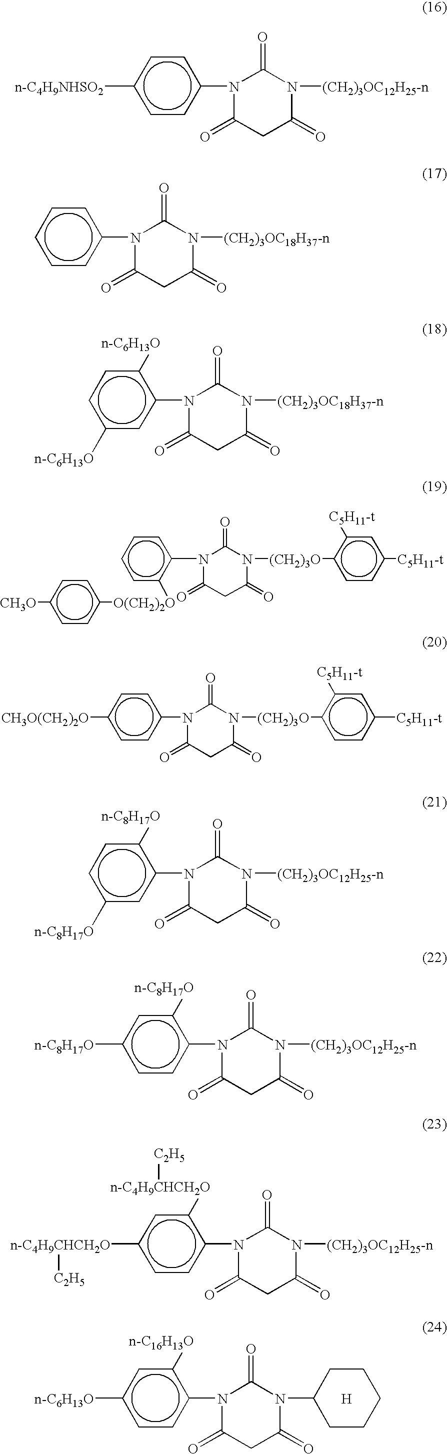

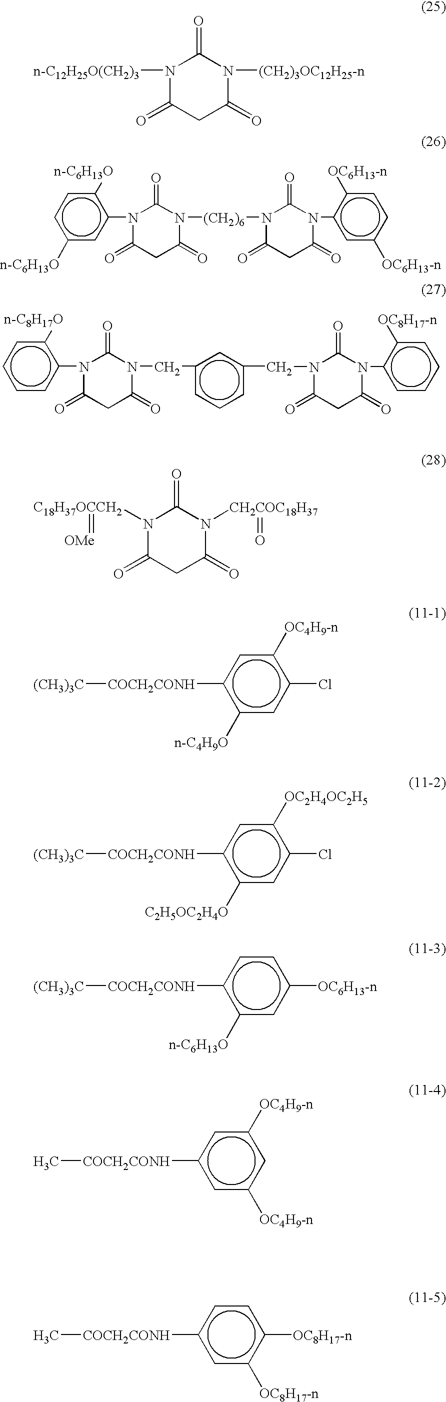

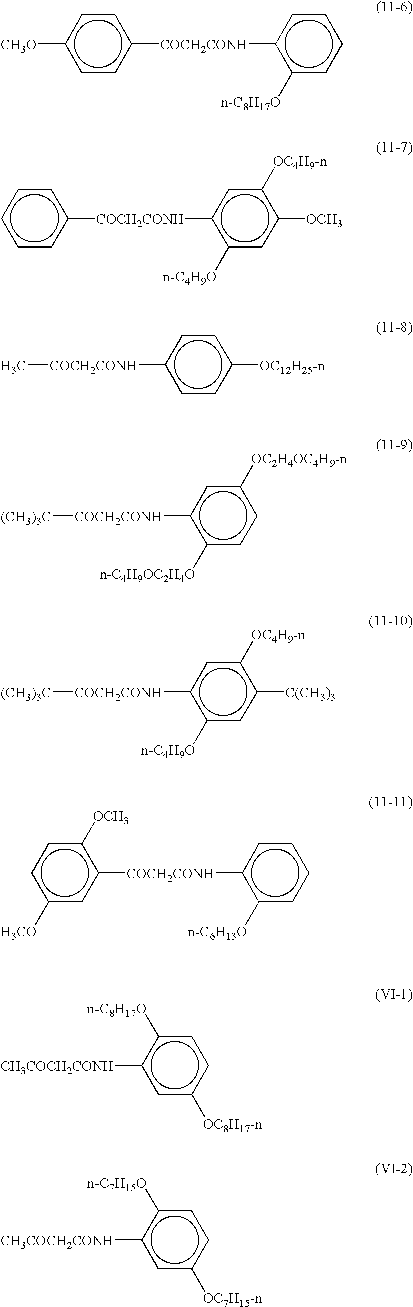

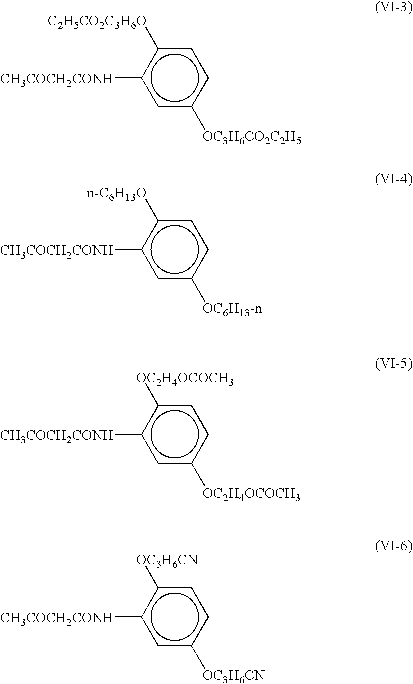

The content of the coupler compound in the heat-sensitive recording layer is preferably from 0.5 to 20 parts by mass, and more preferably from 1 to 10 parts by mass, relative to 1 part by mass of the diazonium salt compound. When the content is less than 0.5 parts by mass, sufficient color-developing properties may not be obtained. On the other hand, when the content exceeds 20 parts by mass, coatability may deteriorate.

The coupler compound (together with other components to be optionally added) can be used after dispersing in a water-soluble polymer in a solid state using a sand mill or the like, and can also used as an emulsified product after emulsifying with a proper auxiliary emulsifier. The method of dispersing in a solid state or emulsifying is not specifically limited and a known method can be employed. Details of these methods are described in JP-A Nos. 59-190886, 2-141279, and 7-17145.

Other Components

The heat-sensitive recording layer of the invention may contain basic substances, auxiliary coloring agents, binders, and antioxidants as the other components.

The basic substance is added for the purpose of promoting the coupling reaction between the diazonium salt compound and the coupler compound. Specifically, conventionally known one or more kinds of basic substances can be used, and basic substances described in the item of the coupler compound can be appropriately selected and added.

Examples of the basic substance include nitrogen-containing compounds such as tertiary amines, piperidines, piperazines, amidines, formamidines, pyridines, guanidines, and morpholines.

Among these basic substances, preferable examples are piperazines such as N,N′-bis(3-phenoxy-2-hydroxypropyl)piperazine, N,N′-bis(3-(p-methylphenoxy)-2-hydroxypropyl)piperazine, N,N′-bis(3-(p-methoxyphenoxy)-2-hydroxypropyl)piperazine, N,N′-bis(3-phenylthio-2-hydroxypropyl)piperazine, N,N′-bis(3-(β-naphthoqui)-2-hydroxypropyl)piperazine, N-3-(P-naphthoxy)-2-hydroxypropyl-N′-methylpiperazine, and 1,4-bis((3-(N-methylpiperazino)-2-hydroxy)propyloxy)benzene; morpholines such as N-(3-(β-naphthoxy)-2-hydroxy)propylmorpholine, 1,4-bis((3-morpholino-2-hydroxy)propyloxy)benzene, and 1,3-bis((3-morpholino-2-hydroxy)propyloxy)benzene; piperidines such as N-(3-phenoxy-2-hydroxypropyl)piperidine and N-dodecylpiperidine; and guanidines such as triphenylguanidine, tricyclohexylguanidine, and dicyclohexylphenylguanidine.

The auxiliary coloring agent is added for the purpose of thermally printing rapidly and completely at low energy. The auxiliary coloring agent is a substance which increases a color-developing density during thermal recording or controls a color-developing temperature, and also decrease a melting point of the coupler compound, basic substance or diazonium salt compound, and an action of decreasing a softening point of a capsule wall makes it possible to achieve conditions under which the diazonium salt compound, basic substance or coupler compound is easily reacted.

Examples of the auxiliary coloring agent include phenol derivatives, naphthol derivatives, alkoxy-substituted benzenes, alkoxy-substituted naphthalenes, aromatic ether, thio ether, ester, amide, ureide, urethane, sulfonamide compound, hydroxy and compound.

The binder can be selected from conventionally known ones and examples thereof include water-soluble polymers such as polyvinyl alcohol and gelatin, and polymer latex.

The antioxidant is added for the purpose of improving fastness to light and heat of the thermally color-developing image, or reducing yellowing caused by light of the non-printed portion (non-image portion) after fixing. Examples of the antioxidant include known ones described in EP Laid-Open Nos. 223739, 309401, 309402, 310551, 310552, 459416, GE Laid-Open No. 3435443, JP-A Nos. 54-48535, 62-262047, 63-113536, 63-163351, 2-262654, 2-71262, 3-121449, 5-61166, 5-119449, U.S. Pat. Nos. 4,814,262, and 4,980,275.

Encapsulation Method

As the method for formation of a microcapsule, a conventionally known method for formation of a microcapsule (see, for example, specifications of U.S. Pat. Nos. 3,726,804 and 3,796,669) can be used. For example, an interfacial polymerization method and internal polymerization method are suited. Specifically, a microcapsule is obtained by dissolving a diazonium salt compound in an organic solvent, which is slightly soluble or insoluble in water, together with a microcapsule wall precursor (wall material) thereby to form an oil phase, adding the oil phase in an aqueous solution (aqueous phase) of a water-soluble polymer, emulsifying and dispersing the oil phase using a homogenizer, and heating thereby to form a polymer film (wall film), which serves as a microcapsule wall, at an oil-water interface.

Examples of the polymer substance (wall material), which serves as the wall film, include polyurethane resin, polyurea resin, polyamide resin, polyester resin, polycarbonate resin, aminoaldehyde resin, melamine resin, polystyrene resin, styrene-acrylate copolymer resin, styrene-methacrylate copolymer resin, gelatin, and polyvinyl alcohol. A microcapsule having a wall film made of a polyurethane resin and a polyurea resin is preferable.

An example of a method of preparing a diazonium salt compound-including microcapsule (polyurea-polyurethane wall) will be described below.

First, a diazonium salt compound is dissolved or dispersed in a hydrophobic organic solvent (optionally containing a low-boiling solvent), which serves as a core of a capsule, to prepare an oil phase (organic solvent solution) which serves as a core of a microcapsule. If necessary, polyhydric isocyanate as a wall material may be added to the side of the oil phase, or surfactants may be further added for the purpose of stabilizing by uniformly emulsifying and dispersing. Also, additives such as color-fading inhibitors and stain inhibitors may be added.

The polyhydric isocyanate compound is preferably a compound having a tri- or polyfunctional isocyanate group, and may be a difunctional isocyanate compound. Specific examples thereof include xylene diisocyanate and its hydrogenated compounds, hexamethylene diisocyanate; tolylene diisocyanate and its hydrogenated compounds; polyfunctional compounds obtained by using diisocyanates such as isophorone diisocyanate as a main starting material and performing the addition reaction of dimer or trimer (burette or isocyanurate) of them, polyol such as trimethylolpropan, and difunctional isocyanate such as xylylene diisocyanate; compounds obtained by introducing a high-molecular weight compound having active hydrogen (such as polyethylene oxide) such as polyether into an adduct compound of polyol such as trimethylolpropane and difunctional isocyanate such as xylylene diisocyanate; and formalin condensates of benzene isocyanate.

Compounds described in JP-A Nos. 62-212190, 4-26189, 5-317694, and Japanese Patent Application No. 8-268721 are also preferable.

The amount of the polyhydric isocyanate is decided so as to achieve an average particle size of the microcapsule in a range from 0.3 to 12 μm and a wall thickness in a range from 0.01 to 0.3 μm, and a particle size of dispersed particles is generally from about 0.2 to 10 μm.

A known surfactant for emulsification can be used as the surfactant and the amount of the surfactant is preferably from 0.1 to 5% by mass, and more preferably from 0.5 to 2% by mass, relative to the weight of the oil phase.

In the preparation of the oil phase, an organic solvent having a boiling point of 100 to 300° C. is preferable as the hydrophobic organic solvent in which the diazonium salt compound is dissolved or dispersed, and examples thereof include alkyl naphthalene, alkyl diphenylethane, alkyldiphenylmethane, alkylbiphenyl, alkyl terphenyl, chlorinated paraffin, phosphoric acid esters, maleic acid esters, adipic acid esters, phthalic acid esters, benzoic acid esters, carbonic acid esters, ethers, sulfuric acid esters, and sulfonic acid esters. These organic solvents may be used in combination.

When the diazonium salt compound has poor solubility in aforementioned organic solvent, a low-boiling solvent having high solubility to the diazonium salt compound may be used in combination, and examples of the low-boiling solvent include ethyl acetate, propyl acetate, isopropyl acetate, butyl acetate, methylene chloride, tetrahydrofuran, acetonitrile, and acetone.

The diazonium salt compound preferably has proper solubility in the hydrophobic organic solvent and the low-boiling solvent. For example, the solubility in the solvents is preferably 5% or more because the concentration of the following diazonium salt compound can be easily adjusted. Also, the solubility in water is preferably 1% or less.

Subsequently, the oil phase thus obtained is emulsified and dispersed in an aqueous phase. At this time, an aqueous solution containing a water-soluble polymer dissolved therein is used in the aqueous phase and, after the oil phase was introduced therein, the mixture is emulsified and dispersed by means such as a homogenizer. The water-soluble polymer enables uniform and easy dispersion and also serves as a dispersion medium capable of stabilizing the emulsified and dispersed aqueous solution. For the purpose of further stabilizing by emulsifying and dispersing, the same surfactants as described above may be added.

The water-soluble polymer used in the aqueous phase is preferably a water-soluble polymer having a solubility in water at an emulsifying temperature of 5% or more, and examples thereof include polyvinyl alcohol and its modified compounds, polyacrylic acidamide and its derivatives, ethylene-vinyl acetate copolymer, styrene-maleic anhydride copolymer, ethylene-maleic anhydride copolymer, isobutylene-maleic anhydride copolymer, polyvinyl pyrrolidone, ethylene-acrylic acid copolymer, vinyl acetate-acrylic acid copolymer, carboxymethyl cellulose, methyl cellulose, casein, gelatin, starch derivative, gum arabic, and sodium alginate.

The water-soluble polymer preferably has no or low reactivity with the isocyanate compound. Those having a reactive amino group in the molecular chain, such as gelatin, are preferably modified, thereby to remove reactivity.

In the emulsified dispersion prepared by adding the oil phase in the aqueous phase, the polymerization reaction of the polyhydric isocyanate occurs at the interface between the oil phase and the aqueous phase thereby to form a polyurea wall.

When polyol and/or polyamine are further added in the hydrophobic solvent in the aqueous phase or the oil phase, they react with the polyhydric isocyanate, and thus making it possible to use as one of constituent components of the microcapsule wall. In aforementioned reaction, it is preferable to maintain the reaction temperature at a high temperature or added proper polymerization catalysts in view of an increase in reaction rate.

Specific examples of the polyol or polyamine include propylene glycol, glycerin, trimethylolpropane, triethanolamine, sorbitol, and hexamethylenediamine. In case of the addition of polyol, a polyurethane wall is formed.

Aforementioned polyhydric isocyanate, polyol and reaction catalyst, or polyamine used for formation of a portion of the wall material are described in detail in a relevant document (edited by Keiji IWATA, Polyurethane Handbook, published by THE NIKKAN KOGYO SHIMBUN, LTD., 1987).

The emulsification can be performed by appropriately selecting from known emulsifying apparatuses such as a homogenizer, a Manton-Gaulin, an ultrasonic disperser, a dissolver, and a Kdmill.

After the emulsification, the emulsified product is heated at 30 to 70° C. for the purpose of promoting the capsule wall formation reaction. During the reaction, it is necessary to reduce collision probability of capsules by adding water or sufficiently stir so as to prevent agglomeration of capsules. During the reaction, a dispersed product for prevention of agglomeration may be added.

During the polymerization reaction, evolution of a carbonic acid gas is observed with the progress of the reaction and the end point of the capsule wall formation reaction can be roughly decided by the completion of the evolution. Usually, the objective diazonium salt compound-including microcapsule can be obtained by reacting for several hours.

In the preparation of the coating solution for formation of the heat-sensitive recording layer (coating solution for heat-sensitive recording layer), a coupler which enables the diazonium salt compound to develop a color can be used, together with a water-soluble polymer, an organic base and the other auxiliary coloring agent, by dispersing in a solid state using a sand mill. Particularly preferably, the coupler is used as an emulsified product obtained by previously dissolving the coupler in a high-boiling organic solvent, which is slightly soluble or insoluble in water, mixing the resulting solution with an aqueous polymer solution (aqueous phase) containing a surfactant and/or a water-soluble polymer as a protective colloid, and emulsifying the mixture using a homogenizer. If necessary, a low-boiling solvent may be used as an auxiliary resolvent.

Further, the coupler and the organic base can be separately emulsified and dispersed, or may be mixed, dissolved in a high-boiling organic solvent and then emulsified and dispersed. Preferable particle size of emulsified and dispersed particles is 1 μm or less. The high-boiling organic solvent can be appropriately selected from high-boiling oils described in JP-A No. 2-141279, and esters are preferable and tricresyl phosphate are particularly preferable in view of emulsion stability.

The low-boiling solvent includes the same low-boiling solvents as those in the oil phase.

As the surfactant contained in the aqueous phase, anionic or nonionic surfactants, which do not cause precipitation or agglomeration with the water-soluble polymer, can be appropriately selected, and examples thereof include sodium alkylbenzene sulfonante, sodium alkyl sulfate, dioctyl sodium sulfosuccinate, and polyalkylene glycol (for example, polyoxyethylene nonyl phenyl ether).

Protective Layer

The protective layer usually contains binders, pigments, lubricants, dispersants, fluorescent whitening agents, metal soaps, surfactants, film hardeners, ultraviolet absorbers, and crosslinking agents.

Examples of the binder include water-soluble polymers such as vinyl acetate-acrylamide copolymer, silicon-modified polyvinyl alcohol, starch, modified starch, methyl cellulose, carboxymethyl cellulose, hydroxymethyl cellulose, gelatins, gum arabic, casein, styrene-maleic acid copolymer hydrolyzate, styrene-maleic acid copolymer half ester hydrolyzate, isobutylene-maleic anhydride copolymer hydrolyzate, polyacrylamide derivative, polyvinyl pyrrolidone, sodium polystyrenesulfoate, and sodium alginate; and synthetic rubber latexes and synthetic resin emulsions, such as styrene-butadiene rubber latex, acrylonitrile-butadiene rubber latex, methyl acrylate-butadiene rubber latex, and vinyl acetate emulsion.

Among these binders, gelatins are preferable, and specifically preferable examples of the gelatin include an alkali-treated gelatin having a low isoelectric point and a derivative gelatin obtained by reacting with an amino group (for example, phthalized gelatin).

Examples of the pigment include, but are not limited to, kaolin, carbonic kaolin, talc, agalmatolite, diatomaceous earth, calcium carbonate, aluminum hydroxide, magnesium hydroxide, zinc oxide, lithopone, amorphous silica, colloidal silica, calcined gypsum, silica, magnesium carbonate, titanium oxide, alumina, barium carbonate, barium sulfate, mica, microbaloon, urea-formalin filler, polyester particle, and cellulose filler.

The content of the binder is preferably from 10 to 500% by mass, and more preferably from 50 to 400% by mass, relative to the pigment in the protective layer.

For the purpose of further improving the water resistance, crosslinking agents and catalysts capable of promoting the reaction are effectively used in combination. Preferable examples of the crosslinking agent include epoxy compound, blocked isocyanate, vinylsulfone compound, aldehyde compound, methylol compound, boric acid, carboxylic anhydride, silane compound, chelete compound, and halide, and those capable of adjusting the pH of the coating solution for formation of the protective layer in a range from 6.0 to 7.5 are preferable. Examples of the catalyst include known acids and metal salts, and those capable of adjusting the pH of the coating solution for formation of the protective layer in a range from 6.0 to 7.5 are preferable, similarly.

Preferable examples of the lubricant include zinc stearate, calcium stearate, paraffin wax, and polyethylene wax.

The protective layer may contain surfactants and preferable examples of the surfactant include sulfosuccinic acid-based alkali metal salt and fluorine-containing surfactant, in addition to above-described acetylene glycol-based surfactant and silicone-based surfactant. Specific examples thereof include sodium and ammonium salts of di-(2-ethylhexyl)sulfosuccinic acid and di-(n-hexyl)sulfosuccinic acid.

The coating solution for formation of the protective layer (coating solution for protective layer) can be obtained by mixing aforementioned respective components. Further, releasants, waxes and water repellents may be optionally added.

The protective layer coating solution prepared by mixing these components is applied as it is when a dynamic surface tension at which one bubble is evolved at 200 ms by the valve pressure differential pressure process is 35 mN/m or less, and a dynamic surface tension at which one bubble is evolved at 1000 ms is 30 mN/m or less. When the dynamic surface tension exceeds the above range, the value of the dynamic surface tension of the coating solution is preferably adjusted within the above range by controlling the kind or amount of the surfactant to be added.

The dry coating amount of the protective layer is preferably from 0.2 to 7 g/m², and more preferably from 1 to 4 g/m². When the dry coating amount is less than 0.2 g/m², the water resistance may not be maintained. On the other hand, when it exceeds 7 g/m², thermal sensitivity may drastically deteriorate. After the application of the protective layer, the resulting layer may be subjected to a calendering treatment.

Intermediate Layer

In case of laminating multiple heat-sensitive recording layers, an intermediate layer is preferably provided between the respective heat-sensitive recording layers. Similar to the protective layer, the intermediate layer can contain pigments, lubricants, surfactants, dispersants, fluorescent whitening agents, metal soaps, and ultraviolet absorbers, in addition to various binders. As the binder, the same binder as in the protective layer can be used.

Substrate

Examples of the substrate include plastic film, paper, plastic resin laminate paper, and synthetic paper.

Preparation Method of Heat-Sensitive Material

The preparation method of heat-sensitive material of the invention comprises hardening the layers that contain gelatin or a gelatin derivative as a binder with the active olefin, coating one or more of coating solutions for applying the layers that constitute the heat-sensitive material (namely, coating solutions for heat-sensitive recording layers, and if necessary, coating solutions for the intermediate layers, coating solutions for protective layers, and the like) on the substrate, and drying the coated solutions to form layers.

Specifically, various coating procedures including extrusion coating, slide coating, curtain coating, knife coating, dipping coating, flow coating, and extrusion coating using a hopper described in U.S. Pat. No. 2,681,294 are used. Extrusion coating and slide coating described in “LIQUID FILM COATING” (written by Stephen F. Kistler and Petert M. Schweizer, published by CHAPMAN & HALL in 1997), page 399 to 536 are preferably used, and slide coating is particularly preferably used. An example of a shape of a slide coater used in the slide coating is shown in FIG. 11b1 on page 427 of the same document. Alternatively, plurality of, preferably all of, the heat-sensitive recording layers and other layers such as the intermediate layers and the protective layers provided on or above the same side of the substrate on which the heat-sensitive recording layers are formed, except for undercoat layers, can be formed simultaneously by simultaneous multiple-layer coating of the coating solutions for the respective layers, if necessary, by a method described in page 399 to 536 of the same document, a method described in U.S. Pat. No. 2,761,791, or a method described in British Patent No. 837,095. Such methods exhibit particular effects in forming layers that are adjacent to each other and on or above the same side of the substrate on which the heat-sensitive recording layers are formed.

It is preferable that the drying is conducted by using dry wind of dry bulb temperature in a range from 20 to 65° C., preferably in a range from 25 to 55° C., or by using dry wind of wet bulb temperature in a range from 10 to 30° C., preferably in a range from 15 to 25° C.

Heat-Sensitive Recording Layer

When the heat-sensitive recording material of the invention is a multi-color heat-sensitive recording material, color-developing hue of multiple heat-sensitive recording layers of the material having different color-developing hues is not specifically limited.

For example, when the heat-sensitive recording layer is composed of three layers and the respective color-developing hues are selected from three primary colors such as yellow, magenta and cyan in a subtractive color mixture, full-color image recording can be performed. In this case, color-developing mechanism of a heat-sensitive recording layer (innermost layer) to be directly laminated on the surface of the substrate is not limited to a diazo color-developing system using a combination of a diazonium salt compound and a coupler compound, and may be any of a color-developing system using a combination of an electron-donating dye and an electron-accepting dye capable of reacting with the electron-donating dye thereby to develop a color, a base color-developing system capable of contacting with a basic compound thereby to develop a color, a chelete color-developing system, and a color-developing system capable of reacting with a nucleophilic reagent thereby to cause an elimination reaction and to develop a color. Two heat-sensitive recording layers to be provided on the heat-sensitive recording layer, as the innermost layer, are preferably heat-sensitive recording layers of the diazo color-developing system, which differ in maximum absorption wavelength and also differ in color-developing hue. When the heat-sensitive recording layer, as the innermost layer, is made of the diazo color-developing system, it is necessary that the diazo color-developing system and aforementioned two layers differ in maximum absorption wavelength and also differ in color-developing hue.

Specific examples thereof include those wherein a first heat-sensitive recording layer (layer A) containing an electron-donating colorless dye and an electron-accepting compound, or a diazonium salt compound having a maximum absorption wavelength of shorter than 350 nm and a coupler compound capable of reacting with the diazonium salt compound whiled heated thereby to develop a color, a second heat-sensitive recording layer (layer B) containing a diazonium salt compound having a maximum absorption wavelength of 360+20 nm and a coupler compound capable of reacting with the diazonium salt compound whiled heated thereby to develop a color, and a third heat-sensitive recording layer (layer C) containing a diazonium salt compound having a maximum absorption wavelength of 400±20 nm and a coupler compound capable of reacting with the diazonium salt compound whiled heated thereby to develop a color are laminated in order from the side of the substrate.

Recording of the heat-sensitive recording material will be described by way of aforementioned specific examples. First, the third heat-sensitive recording layer (layer C) is heated so as to develop a color, thereby to enable the diazonium salt compound and the coupler compound contained in the layer to develop a color. Then, the unreacted diazonium salt compound contained in the layer C is decomposed by irradiation with light having a wavelength of 400±20 nm. Then, heat sufficient to enable the second heat-sensitive recording layer (layer B) to develop a color is applied, thereby to enable the diazonium salt compound and the coupler compound contained in the layer to develop a color. At this time, though the layer C is simultaneously heated strongly, the diazonium salt compound has already been decomposed and the color developing capability is lost, and therefore no color is developed. Then, the diazonium salt compound contained in the layer B is decomposed by irradiation with light having a wavelength of 360±20 nm. Finally, heat sufficient to enable the first heat-sensitive recording layer (layer A) to develop a color is applied, thereby to develop a color. At this time, though the layers C and B are simultaneously heated strongly, the diazonium salt compound has already been decomposed and the color developing capability is lost, and therefore no color is developed.

### EXAMPLES

The present invention will be described by way of examples, however, the invention is not limited by these examples. In the examples, parts and percentages are by mass unless otherwise specified.

### Example 1

Preparation of Aqueous Phthalized Gelatin Solution

32 parts of phthalized gelatin (trade name: MGP gelatin, manufactured by Nippi Collagen Cosmetics, Ltd.), 0.9143 parts of 1,2-benzothiazolin-3-one (3.5% methanol solution, manufactured by Daito Chemical Industry Co., Ltd.) and 367.1 parts of deionized water were mixed and dissolved at 40° C. to prepare an aqueous phthalized gelatin solution.

Preparation of Alkali-Treated Gelatin Solution

25.5 parts of an alkali-treated low ion gelatin (trade name: #750 Gelatine, manufactured by Nitta Gelatin Inc.), 0.7286 parts of 1,2-benzothiazolin-3-one (3.5% methanol solution, manufactured by Daito Chemical Industry Co., Ltd.), 0.153 parts of calcium hydroxide and 143.6 parts of deionized water were mixed and dissolved at 50° C. to obtain an aqueous gelatin solution for preparation of an emulsified product.

Preparation of Coating Solution for Yellow Heat-Sensitive Recording Layer

Preparation of Diazonium Salt Compound-Including Microcapsule Solution (a)

To 16.1 parts of ethyl acetate, 3.0 parts of the following compound A (diazonium salt compound, maximum absorption wavelength: 420 nm), 1.4 parts of the following compound B (diazonium salt compound, maximum absorption wavelength: 420 nm), 4.0 parts of monoisopropylbiphenyl, 5.6 parts of diphenyl phthalate and 0.5 parts of diphenyl-(2,4,6-trimethylbenzoyl)phosphine oxide (trade name: Lucilin TPO, manufactured by BASF Japan Ltd.) were added and uniformly dissolved by heating at 40° C.

To the resulting mixed solution, 8.6 parts of a mixture of a xylylene diisocyanate/trimethylolpropane adduct, as a capsule wall material, and a xylylene diisocyanate/bisphenol A adduct (trade name: Takenate D119N (50% by mass of ethyl acetate solution), manufactured by Takeda Chemical Industries, Ltd.) was added, followed by uniform stirring to obtain a mixed solution (I: oil phase).

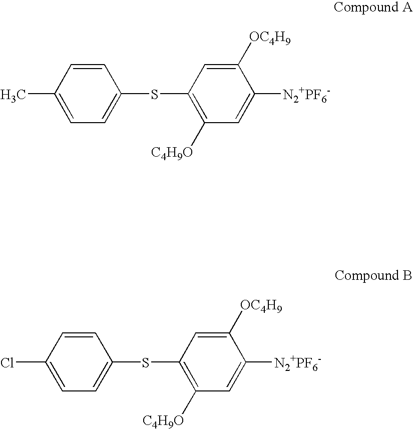

Separately, to 58.6 parts of the aqueous phthalized gelatin solution, 16.3 parts of deionized water and 0.3 parts of a surfactant (Scraph AG-8 (50% by mass; manufactured by Nippon Fine Chemical) was added to obtain a mixed solution (H: aqueous phase).

To the mixed solution (II) obtained above, the mixed solution (1) was added, and then emulsified and dispersed at 40° C. using a homogenizer (trade name, manufactured by Nihon Seiki Seisakusyo Co., Ltd.). To the resulting emulsion, 20 parts of water was added and, after uniformalizing and stirring at 40° C., the encapsulization reaction was conducted for 3 hours while ethyl acetate was removed. 4.1 parts of an ion-exchange resin AMBERLITE® IRA68 (manufactured by Rohm and Hass Co.) and 8.2 parts of AMBERLITE® IRC50 (manufactured by Rohm and Hass Co.) were added, followed by stirring for 1 hour.

Subsequently, the ion-exchange resin was removed by filtration and the concentration was adjusted so that the solid content of the microcapsule solution became 20.0% to obtain a diazonium salt compound-including microcapsule solution (a). The particle size of the resulting microcapsule was measured by using LA-700 (trade name, manufactured by Horiba, Ltd.). As a result, the particle size was 0.38 μm in terms of a median size.

Preparation of Coupler Emulsion (a)

In 33.0 parts of ethyl acetate, 9.9 parts of the following coupler compound (C), 9.9 parts of triphenylguanidine (manufactured by Hodogaya Chemical Co., Ltd.), 18.8 parts of 4,4′-(m-phenylenediisopropylidene)diphenol (trade name: Bisphenol M, manufactured by Mitsui Petrochemical Co., Ltd.), 5.3 parts of 3,3,3′,3′-tetramethyl-5,5′,6,6′-tetra(1-propyloxy)-1,1′-spirobisindane, 13.6 parts of 4-(2-ethylhexyloxy)benzene sulfonic acid amide (manufactured by MANAC Incorporated), 6.8 parts of 4-n-pentyloxybenzenesulfonic acid amide (manufactured by MANAC Incorporated) and 4.2 parts of calcium dodecylbenzenesulfonate (trade name: Pionin A-41-C (70% methanol solution), manufactured by Takemoto Oil&Fat.) were dissolved to obtain a mixed solution (III).

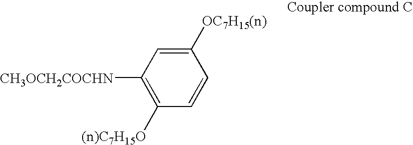

Separately, 206.3 parts of the aqueous alkali-treated gelatin solution obtained above was mixed with 107.3 parts of deionized water to obtain a mixed solution (IV).

Subsequently, to the mixed solution (IV), the mixed solution (III) was added, and then emulsified and dispersed at 40° C. using a homogenizer (manufactured by Nihon Seiki Seisakusyo Co., Ltd.). The resulting coupler emulsion was heated under reduced pressure thereby to remove ethyl acetate, and then the concentration was adjusted so that the solid content became 26.5% by mass. The particle size of the resulting coupler emulsion (a) was measured by LA-700 (trade name, manufactured by Horiba, Ltd.). As a result, the particle size was 0.23 μm in terms of a median size.

Further, to 100 parts of the coupler emulsion after adjusting the concentration, 9 parts of a SBR latex (trade name: SN-307 (48%), manufactured by Sumitomo ABS Latex Co., Ltd.) after adjusting the concentration to 26.5% was added, followed by uniform stirring to obtain a coupler emulsion (a).

Preparation of Coating Solution for Yellow Heat-Sensitive Recording Layer

The diazonium salt compound-including microcapsule solution (a) obtained above and the coupler emulsion (a) obtained above were mixed in a mass ratio, coupler compound/diazonium salt compound, of 2.2/1 to obtain a coating solution for yellow heat-sensitive recording layer.

Preparation of Coating Solution for Magenta Heat-Sensitive Recording Layer

Preparation of Diazonium Salt Compound-Including Microcapsule Solution (b)

To 12.8 parts of ethyl acetate, 3.8 parts of the following compound D (diazonium salt compound, maximum absorption wavelength: 365 nm), 3.2 parts of isopropylbiphenyl, 3.2 parts of tricresyl phosphate, 3.2 parts of phenyl phthalate, 1.1 parts of dibutyl sulfate, 0.38 parts of ethyl 2,4,6-trimethylbenzoylphenylphosphinate ester and 0.15 parts of calcium dodecylbenzene sulfonate (surfactant; trade name: Pionin A-41-C (70% methanol solution), manufactured by Takemoto Oil&Fat.) were added and uniformly dissolved by heating.

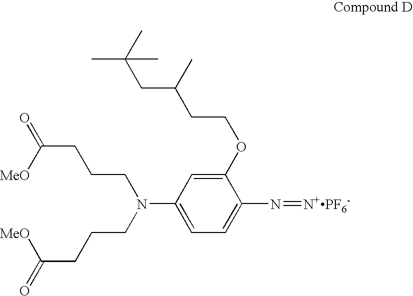

To the resulting mixed solution, 10.9 parts of a xylylene diisocyanate/trimethylolpropane adduct (trade name: Takenate D110N (75% ethyl acetate solution), manufactured by Takeda Chemical Industries, Ltd.), as a capsule wall material, was added, followed by uniform stirring to obtain a mixed solution (V: oil phase).

Separately, 59.9 parts of the aqueous phthalized gelatin solution was mixed with 22.8 parts of deionized water to obtain a mixed solution (VI: aqueous phase).

To the mixed solution (VI), the mixed solution (V) was added, and then emulsified and dispersed at 40° C. using a homogenizer (manufactured by Nihon Seiki Seisakusyo Co., Ltd.). To the resulting emulsion, 27.3 parts of water was added and, after uniformalizing and stirring at 40° C., the encapsulization reaction was conducted for 3 hours while ethyl acetate was removed. 1.16 parts of an ion-exchange resin AMBERLITE® IRA6 7 (manufactured by Rohm and Hass Co.) and 2.33 parts of SWA100-HG (tradename, manufactured by Organo Corporation) were added, followed by stirring for 0.5 hours.

Subsequently, the ion-exchange resin was removed by filtration and the concentration was adjusted so that the content of the microcapsule solution became 18.5% to obtain a diazonium salt compound-including microcapsule solution (b). The particle size of the resulting microcapsule was measured by LA-700 (trade name, manufactured by Horiba, Ltd.). As a result, the particle size was 0.57 μm in terms of a median size.

Preparation of Coupler Emulsion (b)

In 33.0 parts of ethyl acetate, 6.3 parts of the following coupler compound (E), 14.0 parts of triphenylguanidine (manufactured by Hodogaya Chemical Co., Ltd.), 14.0 parts of 4,4′-(m-phenylenediisopropylidene)diphenol (trade name: Bisphenol M (manufactured by Mitsui Petrochemical Co., Ltd.), 14 parts of 1,1′-p-hydroxyphenyl)-2-ethylhexane, 3.5 parts of 3,3,3′,3′-tetramethyl-5,5′,6,6′-tetra(1-propyloxy)-1,1′-spirobisindane, 3.5 parts of the following compound (G), 2.5 parts of tricresyl phosphate and 4.5 parts of calcium dodecylbenzene sulfonate (trade name: Pionin A-41-C (70% methanol solution), manufactured by Takemoto Oil&Fat.) were dissolved to obtain a mixed solution (VII).

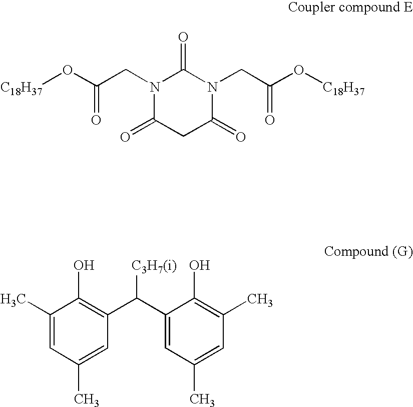

Separately, 206.3 parts of the aqueous alkali-treated gelatin solution obtained above was mixed with 107.3 parts of deionized water to obtain a mixed solution (VIII).

To the mixed solution (VIII), the mixed solution (VII) was added, and then emulsified and dispersed at 40° C. using a homogenizer (manufactured by Nihon Seiki Seisakusyo Co., Ltd.). The resulting coupler emulsion was heated under reduced pressure and ethyl acetate was removed, and then the concentration was adjusted so that the solid content became 24.5% by mass to obtain a coupler emulsion (b). The particle size of the resulting coupler emulsion (b) was measured by LA-700 (trade name, manufactured by Horiba, Ltd.). As a result, the particle size was 0.24 μm in terms of a median size.

Preparation of Coating Solution for Magenta Heat-Sensitive Recording Layer

The diazonium salt compound-including microcapsule solution (b) obtained above and the coupler emulsion (b) obtained above were mixed in a mass ratio, coupler compound/diazonium salt compound, of 1.9/1. Further, 0.015 parts of an aqueous polystyrenesulfonic acid (partially neutralized with potassium hydroxide) solution (5% by mass) was mixed with 10 parts of the diazonium salt compound-including microcapsule solution (b) to obtain a coating solution for magenta heat-sensitive recording layer.

Preparation of Coating Solution for Cyan Heat-Sensitive Recording Layer

Preparation of Electron-Donating Dye Precursor-Including Microcapsule Solution (c)

To 18.1 parts of ethyl acetate, 7.6 parts of the following electron-donating dye precursor (H), 9.0 parts of a mixture of 1-methylpropylphenyl-phenylmethane and 1-(1-methylpropylphenyl)-2-phenylethane (trade name: High Sole SAS-310, manufactured by Nippon Oil Corporation) and 7.0 parts of the following compound (I) (trade name: Irgaperm 2140, manufactured by Ciba Geigy Co.) were added and then uniformly dissolved by heating.

To the resulting mixed solution, 7.2 parts of a xylylene diisocyanate/trimethylolpropane adduct (trade name: Takenate D110N (75% by mass of ethyl acetate solution), manufactured by Takeda Chemical Industries, Ltd.), as a capsule wall material, and 5.3 parts of polymethylene polyphenyl polyisocyanate (trade name: Millionate MR-200, manufactured by NIPPON POLYURETHANE INDUSTRY CO., LTD.) were added, followed by uniform stirring to obtain a mixed solution (IX).

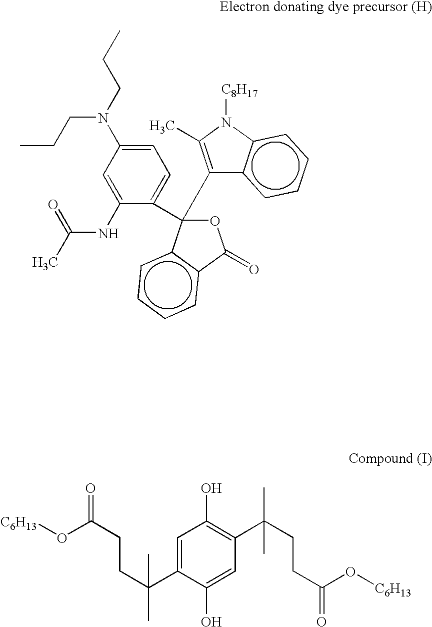

Separately, 28.8 parts of the aqueous phthalized gelatin solution obtained above was mixed with 9.5 parts of deionized water, 0.17 parts of a surfactant (Scraph AG-8 (50% by mass), manufactured by Nippon Fine Chemical) and 4.3 parts of sodium dodecylbenzene sulfonate (10% aqueous solution) to obtain a mixed solution (X).

To the mixed solution (X), the mixed solution (IX) was added, and then emulsified and dispersed at 40° C. using a homogenizer (manufactured by Nihon Seiki Seisakusyo Co., Ltd.) To the resulting emulsion, 50 parts of water and 0.12 parts of tetraethylenepentamine were added and, after uniformalizing and stirring at 65° C., the encapsulization reaction was conducted for 3 hours while ethyl acetate was removed to obtain a microcapsule solution wherein the concentration was adjusted so that the solid content of the microcapsule solution became 33%. The particle size of the microcapsule was measured by LA-700 (trade name, manufactured by Horiba, Ltd.). As a result, the particle size was 1.00 μm in terms of a median size.

Further, to 100 parts of the microcapsule solution after adjusting the concentration, 3.7 parts of a 25% aqueous sodium dodecylbenzene sulfonate solution (trade name: Neopelex F-25, manufactured by Kao Corporation) and 4.3 parts of a fluorescent whitening agent containing a 4,4′-bistriazinylaminostilbene-2,2′-disulfone derivative (trade name: Kaycoll BXNL, manufactured by NIPPON SODA CO., LTD.) were added, followed by uniform stirring to obtain an electron-donating dye precursor-including microcapsule solution (c).

Preparation of Electron-Accepting Compound Dispersion (c)

To 11.3 parts of the aqueous phthalized gelatin solution obtained above, 30.1 parts of deionized water, 15 parts of 4,4′-(p-phenylenediisopropylidene)diphenol (trade name: Bisphenol P, manufactured by Mitsui Petrochemical Co., Ltd.) and 3.8 parts of a 2% aqueous sodium 2-ethylhexyl succinate solution were added, and then dispersed overnight using a ball mill to obtain a dispersion having a solid content of 26.6%.

To 100 parts of the resulting dispersion, 45.2 parts of the aqueous alkali-treated gelatin solution obtained above was added and, after stirring for 30 minutes, deionized water was added so that the solid content of the dispersion became 23.5% to obtain an electron-accepting compound dispersion (c).

Preparation of Coating Solution for Cyan Heat-Sensitive Recording Layer

The electron-donating dye precursor-including microcapsule solution (c) obtained above and the electron-accepting compound dispersion (c) obtained above were mixed in a mass ratio, electron-accepting compound/electron-donating dye precursor, of 10/1 to obtain a coating solution for cyan heat-sensitive recording layer.

Preparation of Coating Solution for Intermediate Layer

100.0 parts of an alkali-treated low ion gelatin (trade name: #750 gelatin, manufactured by Nitta Gelatin Inc.), 2.857 parts of 1,2-benzothazolin-3-one (3.5% methanol solution, manufactured by Daito Chemical Industry Co., Ltd.), 0.5 parts of calcium hydroxide and 521.643 parts of deionized water were mixed and dissolved at 50° C. to obtain an aqueous gelatin solution for preparation of a coating solution for intermediate layer.

10.0 parts of the resulting aqueous gelatin solution, 0.05 parts of sodium (4-nonylphenoxytrioxyethylene)butylsulfonate (manufactured by Sankyo Chemical Co., Ltd.; 2.0% by mass of aqueous solution), 1.5 parts of boric acid (4.0% by mass of aqueous solution), 0.19 parts of an aqueous polystyrenesulfonic acid (partially neutralized with potassium hydroxide) solution (5% by mass), 1.32 parts of a 4% aqueous solution of the following compound (J) (manufactured by Wako Pure Chemical Industries, Ltd.), 0.44 parts of a 4% aqueous solution of the following compound (J′) and 0.67 parts of deionized water were mixed to obtain a coating solution for intermediate layer.

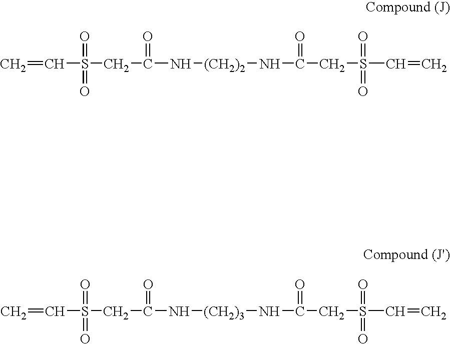

Preparation of Coating Solution for Light Transmittance Adjusting Layer

Preparation of Ultraviolet Absorber Precursor Microcapsule Solution

71 parts of ethyl acetate was mixed with 14.5 parts of [2-allyl-6-(2H-benzotriazol-2-yl)-4-t-octylphenyl]benzenesulfonate, as an ultraviolet absorber precursor, 5.0 parts of 2,2′-t-octylhydroquinone, 1.8 parts of tricresyl phosphate, 5.8 parts of an α-methylstyrene dimer (trade name: MSD-100, manufactured by Mitsui Chemical Co., Ltd.) and 0.45 parts of calcium dodecylbenzene sulfonate (trade name: Pionin A-41-C (70% methanol solution), manufactured by Takemoto Oil&Fat.) and then uniformly dissolved.

To the resulting mixed solution, 54.7 parts of a xylylene diisocyanate/trimethylolpropane adduct (trade name: Takenate D110N (75% by mass of ethyl acetate solution), manufactured by Takeda Chemical Industries, Ltd.), as a capsule wall material, was added, followed by uniform stirring to obtain an ultraviolet absorber precursor mixed solution.

Separately, 52 parts of itaconic acid-modified polyvinyl alcohol (trade name: KL-318, manufactured by Kuraray Co., Ltd.) was mixed with 8.9 parts of a 30% aqueous phosphoric acid solution and 532.6 parts of deionized water to obtain an aqueous ultraviolet absorber precursor PVA solution.

To 516.06 parts of the resulting aqueous ultraviolet absorber precursor PVA solution, the ultraviolet absorber precursor mixed solution was added, and then emulsified and dispersed at 20° C. using a homogenizer (manufactured by Nihon Seiki Seisakusyo Co., Ltd.). To the resulting emulsion, 254.1 parts of deionized water was added and, after uniformalizing and stirring at 40° C., the encapsulization reaction was conducted for 3 hours and 94.3 parts of an ion-exchange resin AMBERLITE® MB-3 (manufactured by Rohm and Hass Co.) was added, followed by stirring for 1 hour.

Subsequently, the ion-exchange resin was removed by filtration and the concentration was adjusted so that the solid content of the microcapsule solution became 13.5%. The particle size of the resulting microcapsule was measured by LA-700 (trade name, manufactured by Horiba, Ltd.). As a result, the particle size was 0.23±0.05 μm in terms of a median size.

859.1 parts of the microcapsule solution was mixed with 2.416 parts of a carboxy-modified styrene-butadiene latex (trade name: SN-307 (48% aqueous solution), manufactured by Sumitomo Naugatuck Co., Ltd.) and 39.5 parts of deionized water to obtain an ultraviolet absorber precursor microcapsule solution.

Preparation of Coating Solution for Light Transmittance Adjusting Layer

1000 parts of the ultraviolet absorber precursor microcapsule solution obtained above, 5.2 parts of a fluorine-based surfactant (trade name: Megafac F-120 (5% aqueous solution), manufactured by DAINIPPON INK & CHEMICALS Co., Ltd.), 7.75 parts of a 4% aqueous sodium hydroxide solution and 73.39 parts of sodium (4-nonylphenoxytrioxyethylene)butylsulfonate (manufactured by Sankyo Chemical Co., Ltd.; 2.0% aqueous solution) were mixed to obtain a coating solution for light transmittance adjusting layer.

Preparation of Coating Solution for Protective Layer

Preparation of PVA Solution for Protective Layer

160 parts of a vinyl alcohol (PVA)-alkyl vinyl ether copolymer (trade name: EP-130, manufactured by Denka Chemical Industries Co., Ltd.), 8.74 parts of a mixed solution of sodium alkyl sulfonate and a polyoxyethylene alkyl ether phosphoric acid ester (trade name: Neoscore CM-57 (54% aqueous solution), manufactured TOHO Chemical Industry Co., LTD.) and 3832 parts of deionized water were mixed and dissolved at 90° C. for 1 hour, followed by uniformalizing to obtain a PVA solution for protective layer.

Preparation of Pigment Dispersion for Protective Layer

8 parts of barium sulfate (trade name: BF-21F (barium sulfate content: 93% or more), manufactured SAKAI CHEMICAL INDUSTRY CO., LTD.) was mixed with 0.3 parts of an anionic special polycarboxylic acid polymer surfactant (trade name: Poise 532A (40% aqueous solution), manufactured by Kao Corporation) and 11.7 parts of deionized water, and then dispersed using a Dyno mill to obtain a barium sulfate dispersion. The particle size was measured by LA-700 (trade name, manufactured by Horiba, Ltd.). As a result, the particle size was 0.17 μm or less in terms of a median size.

To 45.6 parts of the resulting barium sulfate dispersion, 8.1 parts of colloidal silica (SNOWTEX® 0 (20% dispersion), manufactured by Nissan Chemical Industries, Ltd.) was added to obtain a pigment dispersion for protective layer.

Preparation of Matting Agent Dispersion for Protective Layer

220 parts of wheat starch (trade name: Wheat Starch S, manufactured by Shin-Shin Foods Co., Ltd.) was mixed with 3.81 parts of a water dispersion of 1,2-benzisothiazolin-3-one (trade name: manufactured by PROXEL B.D, I.C.I) and 1976.19 parts of deionized water, followed by uniform dispersion to obtain a matting agent dispersion for protective layer.

Preparation of Coating Solution for Protective Layer

1000 parts of the PVA solution for protective layer obtained above, 40 parts of the fluorine-based surfactant (trade name: Megafac F-120 (5% aqueous solution), manufactured by DAINIPPON INK & CHEMICALS Co., Ltd.), 50 parts of sodium (4-nonylphenoxytrioxyethylene)butylsulfonate (manufactured by Sankyo Chemical Co., Ltd.; 2.0% aqueous solution), 49.87 parts of the pigment dispersion for protective layer obtained above, 16.65 parts of the matting agent dispersion for protective layer obtained above, 48.7 parts of a zinc stearate dispersion (trade name: Hydrine F115 (20.5% aqueous solution), manufactured by CHUKYO YUSHI CO., LTD.) and 280 parts of deionized water were uniformly mixed to obtain a coating solution for protective layer.

Preparation of Substrate with Undercoat Layer

Preparation of Coating Solution for Undercoat Layer

40 parts of an enzymatically hydrolyzed gelatin (average molecular weight: 10000, viscosity defined in the PAGI method=15 mP, jelly strength defined in the PAGI method=20 g) was dissolved in 60 parts of deionized water while stirred at 40° C. to prepare an aqueous gelatin solution for preparation of a coating solution for undercoat layer.

Separately, 8 parts of a water-swellable synthetic mica (aspect ratio: 1000; trade name: Somasif ME100, manufactured by Corp Chemical Co., Ltd.) and 92 parts of water were mixed and then wet-dispersed using a bisco mill to obtain a mica dispersion having an average particle size of 2.0 μm. The mica dispersion was uniformly mixed with water to a mica dispersion having a mica density of 5%.

100 parts of an aqueous gelatin solution for preparation of coating solution for undercoat layer, adjusted to 40% at 40° C., was mixed with 120 parts of water and 556 parts of methanol while stirred sufficiently and, after adding 208 parts of the mica dispersion adjusted to 5% and mixing while stirred sufficiently, 9.8 parts of 1.66% polyethylene oxide-based surfactant was added. The liquid temperature was maintained in the range of from 35 to 40° C. and 7.3 parts of a gelatin film hardener as an epoxy compound was added to obtain a coating solution (5.7%) for undercoat layer.

Preparation of Substrate with Undercoat Layer

A wood pulp comprising 50 parts of LBPS and 50 parts of LBPK was subjected to beating by a disk refiner so as to achieve Canadian Freeness of 300 cc, and 0.5 parts of epoxidated beheic acid amide, 1.0 parts of anion polyacrylamide, 1.0 parts of aluminum sulfate, 0.1 parts of polyamidepolyamineepichlorhyrin and 0.5 parts of cation polyacrylamide were added in a bone-dry mass ratio relative to the pulp. Then, a stencil paper having a basis weight of 114 g/m² was made by a Fourdrinier paper machine and the thickness was adjusted to 100 μm by a calendering treatment.

Subsequently, both surfaces of the resulting stencil paper was subjected to a corona discharge treatment and then coated with polyethylene by using a melt-extruder to form a resin layer having a thickness of 36 μm composed of a mat surface (this surface is referred to a “back surface”). The surface opposite the surface, on which the resin layer was formed, was coated with polyethylene containing 10% of anatase titanium dioxide 10% and a trace amount of ultramarine blue by using a melt-extruder to form a resin layer having a thickness of 50 μm composed of a gloss surface (this surface is referred to a “front surface”).

After subjecting the surface of the resin layer of the back surface to a corona discharge treatment, aluminum oxide (trade name: Alumina Sol 100, manufactured by Nissan Chemical Industries, Ltd.), as an antistatic agent, and silicon dioxide (SNOWTEX® 0, manufactured by Nissan Chemical Industries, Ltd.) were dispersed in water in a ratio of ½ (=aluminum oxide/silicon dioxide; mass ratio) and the resulting dispersion was coated thereon in a dry mass of 0.2 g/m².

After subjecting the surface of the polyethylene resin layer of the front surface to a corona discharge treatment, the coating solution for undercoat layer obtained above was coated thereon in a mica coating amount of 0.26 g/m², followed by drying to obtain a substrate with an undercoat layer.

Preparation of Heat-Sensitive Recording Material

On the surface of the undercoat layer provided on the substrate, a coating solution for cyan heat-sensitive recording layer (c), a coating solution for intermediate layer, a coating solution for magenta heat-sensitive recording layer (b), a coating solution for intermediate layer, a coating solution for yellow heat-sensitive recording layer (a), a coating solution for light transmittance adjusting layer and a coating solution for protective layer were coated in this order simultaneously (namely, the above seven layers were coated by simultaneous multiple-layer coating), followed by a drying treatment under drying conditions of 30° C. and 30% RH and drying conditions of 40° C. and 30% to produce a heat-sensitive recording material.

The coating solution for yellow heat-sensitive recording layer (a) was coated so that the total coating amount of the diazonium salt compounds (A) and (B) is 0.156 g/m² relative to the solid content, the coating solution for magenta heat-sensitive recording layer (b) was coated so that the coating amount of the diazonium salt compound (D) is 0.225 g/m² relative to the solid content, and the coating solution for cyan heat-sensitive recording layer (c) was coated so that the coating amount of the electron-donating dye precursor (H) is 0.355 g/m² relative to the solid content.

The coating solution for intermediate layer was coated so that the coating amount of the gelatin is 2.064 g/m² relative to the solid content between the coating solution (a) and the coating solution (b), and the coating amount of the gelatin is 2.885 g/m² relative to the solid content between the coating solution (b) and the coating solution (c) The coating solution for light transmittance adjusting layer was coated so that the coating amount of the gelatin is 2.35 g/m² relative to the solid content, and the coating solution for protective layer was coated so that the coating amount of the gelatin is 1.39 g/m² relative to the solid content.

### Example 2

In the same manner as in Example 1, except that the amounts of the 4% aqueous solutions of the compound (J) and the 4% aqueous solution of the compound (J′) were replaced by 2.30 parts and 0.77 parts in the intermediate layer of Example 1, a heat-sensitive recording material was produced.

### Example 3

In the same manner as in Example 1, except that the amounts of the 4% aqueous solutions of the compound (J) and the 4% aqueous solution of the compound (J′) were replaced by 6.91 parts and 2.30 parts in the intermediate layer of Example 1, a heat-sensitive recording material was produced.

### Example 4

In the same manner as in Example 1, except that the amounts of the 4% aqueous solutions of the compound (J) and the 4% aqueous solution of the compound (J′) were replaced by 13.16 parts and 4.39 parts in the intermediate layer of Example 1, a heat-sensitive recording material was produced.

### Example 5

In the same manner as in Example 1, except that the amounts of the 4% aqueous solutions of the compound (J) and the 4% aqueous solution of the compound (J′) were replaced by 16.45 parts and 5.48 parts in the intermediate layer of Example 1, a heat-sensitive recording material was produced.

### Example 6

In the same manner as in Example 1, except that 3.51 parts of 4,6-bis(vinylsulfonyl)-m-xylene represented by the following structural formula was added in place of the 4% aqueous solutions of the compound (J) and the 4% aqueous solution of the compound (J′) in the intermediate layer of Example 1, a heat-sensitive recording material was produced.

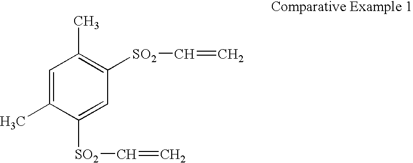

In the same manner as in Example 1, except that the compound (J) and the compound (J′) were not added in the intermediate layer of Example 1, a heat-sensitive recording material was produced.

Evaluation of Color-Developing Density and Gloss of Cyan Heat-Sensitive Recording Layer

With respect to the heat-sensitive recording materials obtained in Examples 1 to 6 and Comparative Example 1, first, the diazonium salt compound of the yellow heat-sensitive recording layer was deactivated by light having a luminescence center wavelength of 420 nm from an ultraviolet lamp having an output of 40 W, and then the diazonium salt compound of the magenta heat-sensitive recording layer was deactivated by light having a luminescence center wavelength of 365 nm from an ultraviolet lamp having an output of 40 W.

Using a thermal head (trade name: KST type, manufactured by Kyocera Corporation), an applied voltage and a pulse width for the thermal head were controlled so that a recording energy per unit area became 100 mJ/mm² and then a cyan heat-sensitive recording layer was thermally printed.

Using a Macbeth densitometer (trade name: Reflection Densitomter RD918, manufactured by Macbeth Co.), a maximum color-developing density (Dmax) was measured by a red filter. The results are shown in Table 1 below.

Using a digital variable angle gloss meter UGV-6P (trade name, manufactured by Suga Test Machine Inc.), gloss of the cyane-colored portion was examined at a measuring angle of 20°. The results are shown in Table 1 below.

TABLE 1

| | Content of active | Gloss of cyan | Density of cyan |
|---|---|---|---|
| | olefin (Note 1) | image | image |
| Example 1 | 2% by mass | 3 | 1.62 |
| Example 2 | 3.5% by mass | 17 | 1.75 |
| Example 3 | 10.5% by mass | 21 | 1.79 |
| Example 4 | 20% by mass | 19 | 1.72 |
| Example 5 | 25% by mass | 17 | 1.68 |
| Example 6 | 4% by mass | 11 | 1.65 |
| Comparative | 0% by mass | 1 | 1.57 |
| Example 1 | | | |

(Note 1)
Amount of active olefin relative to entire gelatin of heat-sensitive recording material

As is apparent from Table 1, the heat-sensitive recording material of the invention, wherein the gelatin layer was hardened with the active olefin, exhibits high image density and gloss at the portion where high-intensity energy is applied (cyan-colored portion) and the image density and gloss are further improved by controlling the amount of the active olefin in a range from 3.5% by mass to 20.0% by mass relative to the gelatin.

The invention provides a heat-sensitive recording material excellent in image density and gloss at the portion where high-intensity energy is applied.

What is claimed is:

1. A heat-sensitive recording material comprising a substrate and a plurality of layers formed on the substrate, wherein
at least two layers among the plurality of layers are heat-sensitive recording layers; and
at least one layer among the plurality of layers contains gelatin or a gelatin derivative as a binder, and is hardened with an active olefin.

2. The heat-sensitive recording material of claim 1, wherein:
the plurality of layers include at least one of an intermediate layer and a protective layer; and
at least one of the intermediate layer and the protective layer is the layer hardened with the active olefin.

3. The heat-sensitive recording material of claim 1, wherein:
the plurality of layers include an intermediate layer; and
the intermediate layer is the layer hardened by the active olefin.

4. The heat-sensitive recording material of claim 1, wherein the active olefin is contained in an amount of 1 to 40% by mass relative to the gelatin or gelatin derivative.

5. The heat-sensitive recording material of claim 4, wherein the active olefin is contained in an amount of 3.5 to 20.0% by mass relative to the gelatin or gelatin derivative.

6. The heat-sensitive recording material of claim 1, wherein the heat-sensitive recording material is a multi-color heat-sensitive recording material.

7. The heat-sensitive recording material of claim 1, wherein the active olefin is a compound having a non-substituted vinyl group activated by an electron attracting group adjacent to double bonds.

8. The heat-sensitive recording material of claim 7, wherein
the electron attracting group is selected from the group consisting of —COR group, —OSO₂R group, —SO₂R group, —SO₂NR¹R² group, —CONR¹R² group, and —COOR group,
in which R, R¹ and R² represent a hydrogen atom, a halogen atom, an alkyl group, an aryl group, or an acyl group; when R, R¹ and R² represent an alkyl group, they may be substituted or non-substituted, may be straight-chain or branched, and may have an unsaturated bond; when R, R¹ and R² represent an aryl group, they may be substituted or non-substituted; and R, R¹ and R² may form a ring.

9. The heat-sensitive recording material of claim 1, wherein at least one of the heat-sensitive recording layers comprises a diazonium salt compound, and a coupler capable of reacting with the diazonium salt compound to thereby develop a color.

10. The heat-sensitive recording material of claim 6, wherein at least one of the heat-sensitive recording layers comprises a diazonium salt compound, and a coupler capable of reacting with the diazonium salt compound to thereby develop a color.

11. The heat-sensitive recording material of claim 9, wherein the diazonium salt compound is contained in microcapsules.

12. The heat-sensitive recording material of claim 10, wherein the diazonium salt compound is contained in microcapsules.

13. The heat-sensitive recording material of claim 9, wherein the diazonium salt compound is a compound represented by the following formula (2): 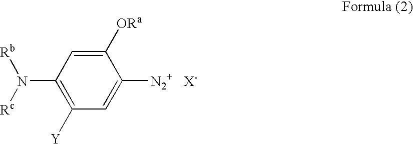
wherein R^{a}, R^{b} and R^{c} each independently represent an alkyl group or an aryl group and may be substituted or non-substituted, and R^{a} to R^{c} may be the same or different.

14. The heat-sensitive recording material of claim 9, wherein the diazonium salt compound is a compound having a maximum absorption wavelength (λₘₐₓ) in a range from 330 to 390 nm.

15. The heat-sensitive recording material of claim 9, wherein the diazonium salt compound has 12 or more carbon atoms, solubility in water of 1% or less, and solubility in ethyl acetate of 5% or more.

16. The heat-sensitive recording material of claim 9, which comprises the coupler in an amount of 0.5 to 20 parts by mass relative to 1 part by mass of the diazonium salt compound.

17. A method for preparing a heat-sensitive recording material comprising hardening a layer that contains gelatin or a gelatin derivative as a binder with an active olefin, wherein:
the heat-sensitive recording material comprises a substrate and a plurality of layers formed on the substrate;
at least two layers among the plurality of layers are heat-sensitive recording layers; and
at least one layer among the plurality of layers is the layer containing the gelatin or the gelatin derivative and hardened with the active olefin.

18. The method of claim 17, wherein the heat-sensitive recording material is a multi-color heat-sensitive recording material.

19. The method of claim 17, wherein:
the plurality of layers include at least one of an intermediate layer and a protective layer; and
at least one of the intermediate layer and the protective layer is the layer containing the gelatin or the gelatin derivative and hardened with the active olefin.

20. The method of claim 17, further comprising forming, by simultaneous multiple-layer coating, all layers provided on or above the same side of the substrate on which the heat-sensitive recording layers are formed except for an undercoat layer.
